(19) United States
(12) Patent Application Publication
(10) Pub. No.: US 2025/0298331 A1
(43) Pub. Date: Sep. 25, 2025

(54) TONER

(71) Applicant: CANON KABUSHIKI KAISHA, Tokyo (JP)

(72) Inventors: KENYA TERADA, Shizuoka (JP); KOSUKE FUKUDOME, Tokyo (JP); TORU ISHII, Shizuoka (JP); KAZUYUKI SATO, Kanagawa (JP); SHOHEI TSUDA, Shizuoka (JP)

(21) Appl. No.: 19/085,779

(22) Filed: Mar. 20, 2025

(30) Foreign Application Priority Data
Mar. 21, 2024 (JP) 2024-044930
Feb. 25, 2025 (JP) 2025-027675

(51) Int. Cl. G03G 9/087; G03G 9/08; G03G 9/093

(52) U.S. Cl. CPC G03G 9/08755; G03G 9/0827; G03G 9/09342

(57) ABSTRACT

A toner includes toner particles each containing a binder resin. The binder resin contains 50% or more by mass of a polyester A containing 60 mol % or more of a unit derived from isophthalic acid as an acid component. The toner includes agglomerates on surfaces of the toner particles, each of the agglomerates containing silica and a resin. The toner has a CI (% by number) of 1% or more by number and 15% or less by number, CI being the percentage by number of the toner particles including the agglomerates. The percentage by number of the toner particles including the agglomerates satisfies predetermined requirements.

### BACKGROUND

### Technical Field

The present disclosure relates to a toner for use in an image-forming method, such as electrophotography.

### Description of the Related Art

A method for visualizing image information via an electrostatic latent image, such as electrophotography, has been applied to copiers, multifunction machines, and printers. In recent years, with the diversification of usage purposes, there has been a demand for further improvements in the image quality and lifetime of main bodies of electrophotographic machines and toner cartridges.

To maintain high image quality throughout the lifetime of toner, it is effective to control the surface characteristics of toner in such a manner that they do not change throughout the lifetime of toner. In a typical electrophotographic process, various fine organic or inorganic powders commonly called external additives are disposed on the surfaces of toner particles to control the surface properties of the toner particles. Furthermore, toner is required to maintain its properties as a toner in a variety of environments in order to provide stable images throughout its lifetime in different regions of the world. External additives play an important role in designing such toner. Typically, silica is widely used as an external additive. Silica imparts flowability to toner and plays an important role in generating and maintaining electric charge through triboelectric charging.

Japanese Patent Laid-Open No. 2017-3851 discloses a toner containing an amorphous composite resin that contains a styrene-based resin component and a polycondensation resin component prepared by the polycondensation of an alkylene oxide adduct of bisphenol A, an isophthalic acid compound, and a saturated aliphatic carboxylic acid compound, in order to produce a toner with excellent low-temperature fixability. When an isophthalic acid compound is used as a raw material, the polymer chains are less entangled than when a terephthalic acid compound or the like is used as a raw material. Thus, a flexible polymer chain is formed, and the melt viscosity during fixing can be reduced.

Japanese Patent Laid-Open No. 2016-65963 discloses a toner on which silica aggregates (silica agglomerates) are used as an external additive in order to achieve high image quality in a high-temperature and high-humidity environment. A technology has been reported for inhibiting fogging associated with charge leakage, which is caused by less hydrophobic areas on the surfaces of the agglomerates that are generated when the agglomerates are disintegrated, by setting the average particle diameter of primary particles of the silica agglomerates to 50 nm or more and 500 nm or less.

The toner disclosed in Japanese Patent Laid-Open No. 2017-3851 has excellent low-temperature fixability. However, due to an increase in external stress on the toner associated with a prolonged lifetime, an external additive is likely to be embedded in the toner particles, thus sometimes causing a decrease in image density when images are formed on a large number of sheets.

The toner disclosed in Japanese Patent Laid-Open No. 2016-65963 can inhibit fogging in a high-temperature and high-humidity environment owing to the silica agglomerates. However, due to an increase in external stress on the toner associated with a prolonged lifetime, the silica agglomerates collapse, thus sometimes causing a decrease in image density when images are formed on a large number of sheets.

Therefore, there is a demand for a toner capable of inhibiting a decrease in image density when images are formed on a large number of sheets.

### SUMMARY

The present disclosure aims to solve the above disadvantages.

One aspect of the present disclosure is directed to providing a toner including toner particles each containing a binder resin. The binder resin contains 50% or more by mass of a polyester A containing 60 mol % or more of a unit derived from isophthalic acid as an acid component. The toner includes agglomerates on surfaces of the toner particles, each of the agglomerates containing silica and a resin. The toner has a CI (% by number) of 1% or more by number and 15% or less by number, CI being the percentage by number of the toner particles including the agglomerates. Expressions (1) and (2) are satisfied:

$$0.9 \leq Ca / CI \leq 1. \qquad expression ( 1 )$$

$$0.1 \leq Cb / CI \leq 0.4 \qquad expression ( 2 )$$

where Ca is the percentage by number of the toner particles including the agglomerates when the toner has been treated under ultrasonic condition A:
ultrasonic condition A: output frequency 30 kHz, output capacity 0.75 W, and irradiation time 300 seconds, and
   Cb is the percentage by number of the toner particles including the agglomerates when the toner has been treated under ultrasonic condition B:
ultrasonic condition B: output frequency 30 kHz, output capacity 25 W, and irradiation time 300 seconds.

Further features of the present disclosure will become apparent from the following description of exemplary embodiments with reference to the attached drawings.

### BRIEF DESCRIPTION OF THE DRAWINGS

FIG. 1 is a representative view of a toner including an agglomerate.

FIG. 2 is an example of an image obtained by performing a predetermined process using ImageJ on an analysis image in a method for assessing the dispersed state of a resin component contained in an agglomerate.

FIG. 3 is an example of an image created by drawing a total of 18 straight line segments at intervals of 10° on the image of FIG. 2, with the midpoint serving as the reference point so that each line passes through it and extends from one edge of the image to the opposite edge.

FIG. 4 is a schematic sectional view of a toner including an agglomerate.

### DESCRIPTION OF THE EMBODIMENTS

In the present disclosure, unless otherwise specified, the expressions “XX or more and YY or less” and “XX to YY” refer to a numerical range that includes the lower limit and the upper limit, which are end points. When the numerical ranges are described in a stepwise manner, the upper and lower limits of each numerical range can be freely combined. The term “monomer unit” refers to a reacted form of a monomer substance in a polymer. In the following description, a toner particle before an agglomerate containing silica and a resin is present on the surface of the toner particle may be referred to as a “toner core particle”.

### Process Leading to the Present Disclosure and its Significance

There has been a disadvantage that a decrease in image density is likely to occur during image formation on a large number of sheets (during durability testing). The inventors have conducted studies and have speculated that a decrease in the flowability of toner is greatly involved in this disadvantage, and collapse of agglomerates, which contain silica and a resin, due to mechanical stress during image formation on a large number of sheets and embedding of an external additive on the surfaces of toner particles have an influence.

The inventors have conducted studies focusing on the collapse of silica agglomerates and have found that by incorporating a resin into the silica agglomerates, the silica agglomerates can be gradually broken down in response to the mechanical stress during image formation on a large number of sheets, thereby making it possible to inhibit the sudden collapse of the silica agglomerates.

Furthermore, the inventors have conducted studies focusing on the embedding of an external additive and have found that by incorporating isophthalic acid into a resin component in toner, the adhesion of the external additive to the surfaces of toner particles can be inhibited to inhibit the embedding of the external additive.

First, the inventors have focused on isophthalic acid, which is a monomer unit of a polyester. Isophthalic acid has two carboxy groups at the meta-positions of the benzene ring. Thus, the use of isophthalic acid is more likely to form a zigzag polymer structure than terephthalic acid, which has two carboxy groups at the para-positions, i.e., a linear structure. This reduces the interaction between polymer chains, making it easier to form a flexible structure and maintain low-temperature fixability. Isophthalic acid has electron-dense sites (partial negative portions) derived from the two carboxy groups at the meta-positions of the benzene ring. These partial negative portions can inhibit the embedding of the external additive containing negatively charged silica and a resin on the surfaces of the toner particles by means of electrostatic repulsion.

Furthermore, the inventors have focused on the relationship between the partial negative portions on the surfaces of the toner particles and the silica agglomerates. The negatively charged fine silica particles contained in the agglomerates electrostatically repel the partial negative portions of the surfaces of the toner particles. Then, when the agglomerates gradually disintegrate to form fine silica particles, the fine silica particles adhere to the toner particles and can impart flowability to the toner as a fresh external additive.

Moreover, the inventors have focused on agglomerates containing silica and a resin. The agglomerates contain the resin that connects silica to the toner particles. Thus, unlike ordinary agglomerates composed of only fine silica particles, the agglomerates do not collapse but gradually disintegrate in response to energy applied. When low energy is applied, the agglomerates do not disintegrate or detach from the toner particles. When high energy is applied, the agglomerates disintegrate and detach from the toner particles. In other words, in the early stages of image formation, the energy given to the agglomerates by agitation and friction is low, and thus the agglomerates do not disintegrate. After images have been formed on a large number of sheets, the agglomerates gradually disintegrate because of the higher energy given by the agitation and friction over a long period of time. In addition, the fine silica particles formed by the disintegration of the agglomerates electrostatically repel the partial negative portions of the toner particles. The silica particles then separate from the toner particles and adhere to the surfaces of other toner particles as a fresh external additive, thereby imparting flowability to the toner. Due to this action, when images are formed on a large number of sheets, the external additive is successively supplied from the agglomerates, so that a decrease in image density can be inhibited.

In light of the above, the inventors have conducted intensive studies and have found that a toner having the following principal configuration can maintain flowability and inhibit a decrease in image density over a long period of use.

In a toner including toner particles each containing a binder resin, and an external additive,
1) the binder resin contains 50% or more by mass of a polyester A containing 60 mol % or more of a unit derived from isophthalic acid as an acid component, and
2) the toner includes at least the toner particles.

The toner includes agglomerates on surfaces of the toner particles, each of the agglomerates containing silica and a resin.

The toner has a CI (% by number) of 1% or more by number and 15% or less by number, CI being the percentage by number of the toner particles including the agglomerates.

### Expressions (1) and (2) are Satisfied:

$$0.9 \leq Ca / CI \leq 1. \qquad expression ( 1 )$$

$$0.1 \leq Cb / CI \leq 0.4 \qquad expression ( 2 )$$

where Ca is the percentage by number of the toner particles including the agglomerates when the toner has been treated under ultrasonic condition A:
ultrasonic condition A: output frequency 30 kHz, output capacity 0.75 W, and irradiation time 300 seconds, and
   Cb is the percentage by number of the toner particles including the agglomerates when the toner has been treated under ultrasonic condition B:
ultrasonic condition B: output frequency 30 kHz, output capacity 25 W, and irradiation time 300 seconds.

As a result, it has been found that the flowability can be maintained through the image formation on a large number of sheets, and the decrease in image density can be significantly inhibited.

The following provides a detailed explanation based on the above mechanism, including the preferred scope of the present disclosure.

The toner according to an embodiment of the present disclosure includes the toner particles containing the binder resin.

The binder resin contains 50% or more by mass of the polyester A. The polyester A is required to contain 60 mol % or more of the unit (Uᵢₛₒ) derived from isophthalic acid based on all units derived from acid components, that is, Uᵢₛₒ/all units derived from acid components)×100 is 60 mol % or more. This not only improves the low-temperature fixability, but also inhibits the embedding of the external additive on the surfaces of the toner particles by means of electrostatic repulsion, thereby making it possible to inhibit a decrease in image density when images are formed on a large number of sheets. Uᵢₛₒ/all units derived from acid components×100 can be 90 mol % or more.

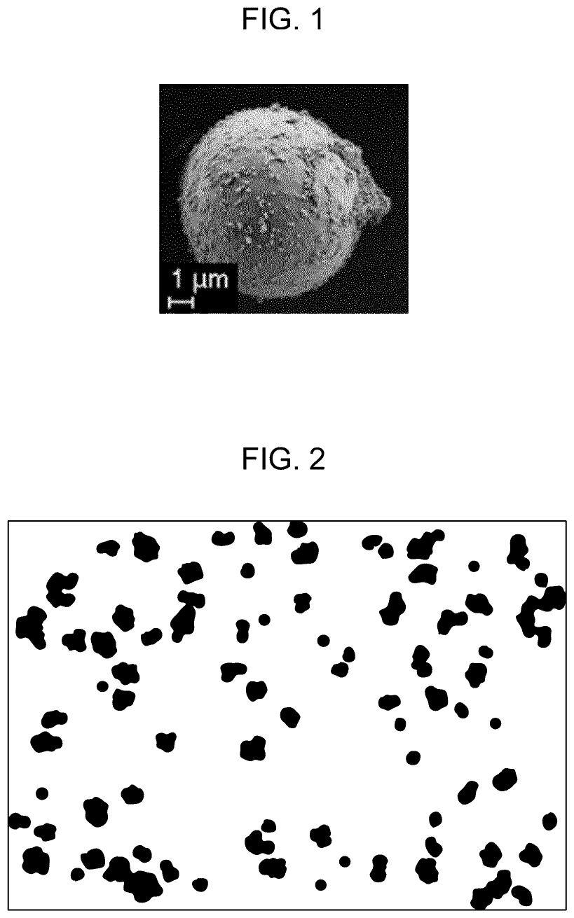

The toner according to an embodiment of the present disclosure requires the agglomerates containing silica and the resin on the surfaces of the toner particles. FIG. 1 is a representative view of a toner including an agglomerate on the surface of a toner particle.

The agglomerates containing silica and the resin include, for example, particles mainly composed of silica, and a resin that can bond the particles together. As the particles mainly composed of silica, for example, both fine dry silica particles produced by what is called a dry process or fumed silica by vapor-phase oxidation of a silicon halide, and what is called fine wet silica particles produced from water glass or the like can be used. These particles may be subjected to hydrophobization treatment. Examples of the treatment agent used for the hydrophobization treatment include silicone varnish, various modified silicone varnishes, silicone oil, various modified silicone oils, silane compounds, silane coupling agents, other organosilicon compounds, and organotitanium compounds. These may be used alone or in combination of two or more.

Regarding the proportion of the agglomerates contained in the toner, CI (% by number), which is the percentage by number of the toner particles including the agglomerates, is required to be 1.0% or more by number and 15.0% or less by number. When CI is 1.0% or more by number, it is possible to inhibit a decrease in image density due to insufficient supply of the external additive when image formation is performed on a large number of sheets. When CI is 15.0% or less by number, it is possible to effectively inhibit a decrease in image density due to the soiling of a conductive member, such as a charging roller, which is caused by excessive agglomerates, during image formation on a large number of sheets.

The toner according to an embodiment of the present disclosure is required to satisfy the relationships represented by expressions (1) and (2):

$$0.9 \leq Ca / CI \leq 1. \qquad expression ( 1 )$$

$$0.1 \leq Cb / CI \leq 0.4 \qquad expression ( 2 )$$

Ca (% by number) is the percentage by number of the toner particles including the agglomerates in the toner that has been treated under ultrasonic condition A: ultrasonic condition A: output frequency 30 kHz, output capacity 0.75 W, and irradiation time 300 seconds, and

Cb (% by number) is the percentage by number of the toner particles including the agglomerates in the toner that has been treated under ultrasonic condition B: ultrasonic condition B: output frequency 30 kHz, output capacity 25 W, and irradiation time 300 seconds.

When the Ca/CI range is 0.90 or more, the disintegration of the agglomerates due to weak shear is inhibited, and the supply of the external additive is stabilized when images are formed on a large number of sheets, thereby making it possible to inhibit a decrease in image density.

When the Cb/CI range is 0.40 or less, the agglomerates disintegrate when subjected to an appropriate shear, and thus the supply of the external additive is stabilized when images are formed on a large number of sheets, thereby making it possible to inhibit a decrease in image density.

The polyester A contains a unit (U_{EO}) derived from an ethylene oxide adduct of bisphenol A and a unit (U_{PO}) derived from a propylene oxide adduct of bisphenol A, and the total proportion of the unit U_{EO} and the unit U_{PO} can be 90 mol % or more based on all units derived from alcohol components. The ethylene oxide adduct of bisphenol A and the propylene oxide adduct of bisphenol A have benzene rings in their main chains and thus improve the durability of the toner, making it possible to inhibit a decrease in image density when images are formed on a large number of sheets.

In the polyester A, the proportion of the unit U_{EO} to the sum of the proportion of the unit U_{EO} and the proportion of the unit U_{PO}, U_{EO}/(U_{EO}+U_{PO})×100, can be 15 mol % or more and 40 mol % or less. U_{PO} is a unit in which propylene oxide, which has a large number of carbon atoms and a branched structure, compared with U_{EO}, is added to bisphenol A. When U_{EO}/(U_{EO}+U_{PO})×100 is 15 mol % or more, the density of the benzene rings in the main chain is increased, thus improving the durability of the toner particles. When U_{EO}/(U_{EO}+U_{PO})×100 is 40 mol % or less, the density of hydrocarbon in the main chain increases, thus improving the durability of the toner particles. Thereby, a decrease in image density when images are formed on a large number of sheets can be inhibited. For the above reasons, U_{EO}/(U_{EO}+U_{PO})×100 can be 15 mol % or more and 40 mol % or less.

When the number-average molecular weight (Mn) and the weight-average molecular weight (Mw) of the tetrahydrofuran (THF)-soluble matter of the polyester A are measured by gel permeation chromatography (GPC), the number-average molecular weight (Mn) can be 3,000 or more and 10,000 or less, and the ratio (Mw/Mn) can be 2.5 or more. When the number-average molecular weight (Mn) is 3,000 or more, the embedding of the external additive due to the toner particles having too low strength can be inhibited, thereby making it possible to inhibit a decrease in image density when images are formed on a large number of sheets. When the number-average molecular weight (Mn) is 10,000 or less, the collapse of the agglomerates due to too high strength of the toner particles can be inhibited, thereby making it possible to inhibit a decrease in image density when images are formed on a large number of sheets. The number-average molecular weight (Mn) may be 4,000 or more and 8,000 or less. A (Mw/Mn) ratio of 2.5 or more indicates that the molecular weight distribution of the polyester A is sufficiently broad, and the toner particles have high flexibility. As a result, extreme deformation of the toner when an impact is applied can be inhibited. As a result, extreme deformation of the toner at the time of the application of an impact can be inhibited. Furthermore, the collapse of the agglomerates at the time of the application of an impact to the toner can be inhibited, thereby making it possible to inhibit a decrease in image density when images are formed on a large number of sheets.

The toner particles can contain aluminum element in an amount of 0.015% or more by mass and 0.150% or less by mass. When the amount of aluminum element is within the above range, aluminum forms a cross-linked structure in the toner particles. As a result, elasticity is imparted to the toner particles to inhibit the plastic deformation of the toner particles, and the disintegration of the agglomerates when images are formed on a large number of sheets is stabilized, thereby making it possible to inhibit a decrease in image density.

The binder resin can further contain a crystalline polyester. In this configuration, the use of the crystalline polyester improves the fixing property. The crystalline polyester can be contained in the binder resin in an amount of 3.0% or more by mass and 30.0% or less by mass. Preferred examples of the crystalline polyester will be described below.

The toner can have an average circularity of 0.950 or more and 0.980 or less. In this case, even if a strong impact is applied to the toner, pressure concentration can be relaxed, and agglomerates can be stably disintegrated, thereby making it possible to inhibit a decrease in image density when images are formed on a large number of sheets. When the average circularity is 0.980 or less, the disintegration of the agglomerates due to too high flowability of the toner can be stabilized, thereby making it possible to inhibit a decrease in image density when images are formed on a large number of sheets.

The agglomerates can have an area fraction of a resin component of the agglomerates of 5% or more and 50% or less based on a total area of the agglomerates on a surface of the toner observed with a scanning electron microscope. In this case, the agglomerates contain an appropriate amount of the resin component, so that the disintegration of the agglomerates is appropriately controlled to provide the effects of the present disclosure at a high level. When the area fraction is smaller than this range, the agglomerates detach easily, thus making it difficult to provide the effect of inhibiting a decrease in image density when images are formed on a large number of sheets. When the area fraction is larger than this range, the agglomerates do not easily detach, thus making it difficult to provide the effect of inhibiting a decrease in image density when images are formed on a large number of sheets. The area fraction of the resin component of the agglomerates can be controlled by adjusting the mixing ratio of the fine silica particles and a binder component, and production conditions, such as stirring conditions.

The agglomerates can have an arithmetic mean value Ag of Feret's diameters of 1,000 nm or more and 8,000 nm or less. When the agglomerates are in the above range, the agglomerates are sufficiently large, and thus the toner including the agglomerates is agitated in the container for a longer period of time. As a result, the agglomerates easily have an opportunity to detach, and a decrease in image density can be inhibited when images are formed on a large number of sheets.

Preferred constituent components and embodiments of the toner particles will be described below.

### Binder Resin

The toner particles contain the binder resin. The binder resin content can be 50% or more by mass based on the total amount of the resin components in the toner particles. The binder resin may contain a polyester other than the polyester A. For example, the binder resin may contain a styrene-acrylic resin, an epoxy resin, a polyester, a polyurethane, a polyamide, a cellulose resin, a polyether, or a mixed or composite resin thereof.

### Polyester A

As described above, the polyester A is required to contain 60 mol % or more of the unit Uᵢₛₒ derived from isophthalic acid based on all the units derived from the acid components, and the polyester A can contain 90 mol % or more of the unit Uᵢₛₒ. The Polyester A used for the toner particles can be an amorphous polyester.

It is sufficient to use the unit derived from isophthalic acid as an essential component, and examples thereof include the following.

The polyester is obtained by selecting and combining suitable materials from a polyvalent carboxylic acid, a polyol, a hydroxycarboxylic acid, and so forth, and performing synthesis using a known method, such as an ester exchange method or a polycondensation method. The polyester can include a polycondensate of a dicarboxylic acid and a diol.

A polycarboxylic acid is a compound containing two or more carboxy groups in one molecule. Of these, a dicarboxylic acid, which is a compound containing two carboxy groups in one molecule, can be used. Examples thereof include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid.

Examples of the polyvalent carboxylic acid other than the dicarboxylic acid include trimellitic acid, trimesic acid, pyromellitic acid, naphthalene tricarboxylic acid, naphthalene tetracarboxylic acid, pyrene tricarboxylic acid, pyrene tetracarboxylic acid, itaconic acid, glutaconic acid, n-dodecylsuccinic acid, n-dodecenyl succinic acid, isododecylsuccinic acid, isododecenylsuccinic acid, n-octylsuccinic acid, and n-octenylsuccinic acid. These may be used alone or in combination of two or more.

A polyol is a compound containing two or more hydroxy groups in one molecule. Of these, a diol is a compound containing two hydroxy groups in one molecule and can be used. Specific examples thereof include ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecandiol, 1,13-tridecanediol, 1,14-tetradecanediol, 1,18-octadecanediol, 1,14-eicosanedecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, and adducts of the aforementioned bisphenols with alkylene oxides, such as ethylene oxide, propylene oxide, and butylene oxide.

Among these, preferred are alkylene glycols each having 2 or more and 12 or less carbon atoms and alkylene oxide adducts of bisphenols, and particularly preferred are alkylene oxide adducts of bisphenols and their combined use with alkylene glycols each having 2 or more and 12 or less carbon atoms. Examples of the alkylene oxide adduct of bisphenol A include compounds represented by the following formula (A):

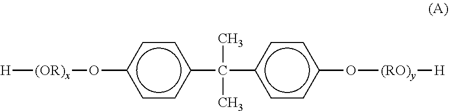

where in formula (A), each R is independently an ethylene group or a propylene group, x and y are each an integer of 0 or more, and the average value of x+y is 0 or more and 10 or less.

The alkylene oxide adduct of bisphenol A is preferably a propylene oxide adduct of bisphenol A and/or an ethylene oxide adduct of bisphenol A, more preferably a propylene oxide adduct of bisphenol A. The average value of x+y can be 1 or more and 5 or less.

Examples of a trihydric or higher alcohol include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of the aforementioned trihydric or higher polyhydric phenols. These may be used alone or in combination of two or more.

The acid value of the polyester A can be 4.0 mgKOH/g or more and 10.0 mgKOH/g or less.

### Agglomerate

The agglomerates containing silica and the resin specifically include particles mainly composed of silica and a resin component that can bond the particles together.

As the particles mainly composed of silica, for example, both fine dry silica particles produced by what is called a dry process or fumed silica by vapor-phase oxidation of a silicon halide, and what is called fine wet silica particles (hereinafter, also referred to as “colloidal silica”) produced from water glass or the like can be used. These particles may be subjected to hydrophobization treatment. Examples of the treatment agent used for the hydrophobization treatment include silicone varnish, various modified silicone varnishes, silicone oil, various modified silicone oils, silane compounds, silane coupling agents, other organosilicon compounds, and organotitanium compounds. These may be used alone or in combination of two or more.

The fine silica particles preferably have a number average particle diameter of primary particles of 10 nm or more and 200 nm or less, more preferably 15 nm or more and 150 nm or less. The number average particle diameter of the primary particles of the fine silica particles can be measured using an enlarged photograph of the toner taken with a scanning electron microscope.

The resin component that can bond the fine silica particles together is required to have an appropriate strength for fixing the particles and to have no adverse effects even when subjected to mechanical stress or changes in environmental conditions, such as temperature and humidity, during a development process. As such a material, for example, a vinyl resin and a polyester can be suitably used, and the vinyl resin is particularly suitable. These can hold the fine silica particles with an appropriate fixing strength, and as the toner is used, the fine silica particles can be continuously supplied to the development process. In addition, although the resin component itself is also supplied to the development process at the same time, the soiling of a member and changes in development characteristics can be inhibited by appropriately selecting the hardness of the resin component and its responsiveness to changes in environmental conditions, such as temperature and humidity. Specific materials will be described in the production method section below.

### Crystalline Polyester

The toner particles can contain the crystalline polyester. The crystalline polyester can be a polycondensate of monomers including an aliphatic diol and/or an aliphatic dicarboxylic acid. The term “crystalline polyester” refers to a polyester that has a distinct melting point as measured using a differential scanning calorimeter (DSC).

The crystalline polyester preferably contains a monomer unit derived from an aliphatic diol having 2 or more and 12 or less, more preferably 6 or more and 12 or less, carbon atoms, and/or a monomer unit derived from an aliphatic dicarboxylic acid having 2 or more and 12 or less, more preferably 6 or more and 12 or less carbon atoms.

The use of the crystalline polyester having such a structure improves the dispersibility of the crystalline polyester between the toner particles and inhibits the melt-adhesion of the toner particles. This makes it possible to stably disintegrate the agglomerates and inhibit a decrease in image density when images are formed on a large number of sheets.

Examples of the aliphatic diol having 2 or more and 12 or less carbon atoms include the following compounds: 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, and 1,12-dodecanediol.

An aliphatic diol having a double bond can also be used. Examples of the aliphatic diol having a double bond include the following compounds: 2-butene-1,4-diol, 3-hexene-1,6-diol, and 4-octene-1,8-diol.

Examples of the aliphatic dicarboxylic acid having 2 or more and 12 or less carbon atoms include the following compounds: oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, and 1,12-dodecanedicarboxylic acid. Lower alkyl esters and acid anhydrides of these aliphatic dicarboxylic acids can also be used. Of these, sebacic acid, adipic acid, and 1,10-decanedicarboxylic acid, and lower alkyl esters and anhydrides thereof can be used. They can be used alone or as a mixture of two or more.

An aromatic dicarboxylic acid can also be used. Examples of the aromatic dicarboxylic acid can include the following compounds: terephthalic acid, isophthalic acid, 2,6-naphthalenedicarboxylic acid, and 4,4′-biphenyldicarboxylic acid. Of these, terephthalic acid can be used because it is easily available and can easily form a polymer having a low melting point.

A dicarboxylic acid having a double bond can also be used. The dicarboxylic acid having a double bond can be used to inhibit hot offset during fixing, because the double bond can be used to cross-link the entire resin.

Examples of such a dicarboxylic acid include fumaric acid, maleic acid, 3-hexenedioic acid, and 3-octenedioic acid. In addition, their lower alkyl esters and acid anhydrides can also be exemplified. Among these, fumaric acid and maleic acid can be used.

Any method for producing the crystalline polyester can be employed. The crystalline polyester can be produced by a common polyester polymerization method in which a dicarboxylic acid component and a diol component are reacted together. For example, the crystalline polyester can be produced by a direct polycondensation method or a transesterification method, depending on the type of monomer.

The peak temperature of the maximum endothermic peak measured using a differential scanning calorimeter (DSC) of the crystalline polyester is preferably 50.0° C. or higher and 100.0° C. or lower, more preferably 60.0° C. or higher and 90.0° C. or lower, from the viewpoint of low-temperature fixability.

### Release Agent

The toner may contain a release agent as necessary in order to inhibit a decrease in image density when images are formed on a large number of sheets. As the release agent, any known release agent can be used. Specific examples of the release agent include petroleum-based waxes, such as paraffin wax, microcrystalline wax, petrolatum and derivatives thereof, montan wax and derivatives thereof, hydrocarbon waxes obtained by the Fischer-Tropsch process and derivatives thereof, polyolefin waxes typified by polyethylene and polypropylene, and derivatives thereof, natural waxes, such as carnauba wax and candelilla wax, and derivatives thereof, and ester waxes. Here, the derivatives include oxides, block copolymers with vinyl-based monomers, and graft-modified products. As the ester wax, monofunctional ester wax, difunctional ester wax, and multifunctional ester wax, such as tetrafunctional and hexafunctional ester waxes, can be used.

The melting point of the release agent is preferably 60° C. or higher and 140° C. or lower, more preferably 70° C. or higher and 130° C. or lower. When the melting point is 60° C. or higher and 140° C. or lower, the toner is easily plasticized during fixing, thereby inhibiting a decrease in image density when images are formed on a large number of sheets. In addition, even if the product is stored for a long period of time, the release agent is unlikely to bleed out.

### Colorant

Examples of the colorant include organic pigments, organic dyes, and inorganic pigments. Any known colorants can be used without any particular limitation.

Examples of cyan colorants include copper phthalocyanine compounds and derivatives thereof, anthraquinone compounds, and basic dye lake compounds. Specific examples thereof include C.I. Pigment Blue 1, C.I. Pigment Blue 7, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 60, C.I. Pigment Blue 62, and C.I. Pigment Blue 66.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds, and perylene compounds.

Specific examples thereof include C.I. Pigment Red 2, C.I. Pigment Red 3, C.I. Pigment Red 5, C.I. Pigment Red 6, C.I. Pigment Red 7, C.I. Pigment Violet 19, C.I. Pigment Red 23, C.I. Pigment Red 48:2, C.I. Pigment Red 48:3, C.I. Pigment Red 48:4, C.I. Pigment Red 57:1, C.I. Pigment Red 81:1, C.I. Pigment Red 122, C.I. Pigment Red 144, C.I. Pigment Red 146, C.I. Pigment Red 150, C.I. Pigment Red 166, C.I. C.I. Pigment Red 169, C.I. Pigment Red 177, C.I. Pigment Red 184, C.I. Pigment Red 185, C.I. Pigment Red 202, C.I. Pigment Red 206, C.I. Pigment Red 220, C.I. Pigment Red 221, and C.I. Pigment Red 254.

Examples of yellow colorants include condensed azo compounds, isoindolinone compounds, anthraquinone compounds, azo metal complexes, methine compounds, and allylamide compounds. Specific examples thereof include C.I. Pigment Yellow 12, C.I. Pigment Yellow 13, C.I. Pigment Yellow 14, C.I. Pigment Yellow 15, C.I. Pigment Yellow 17, C.I. Pigment Yellow 62, C.I. Pigment Yellow 74, C.I. Pigment Yellow 83, C.I. Pigment Yellow 93, C.I. Pigment Yellow 94, C.I. Pigment Yellow 95, C.I. Pigment Yellow 97, C.I. Pigment Yellow 109, C.I. Pigment Yellow 110, C.I. Pigment Yellow 111, C.I. Pigment Yellow 120, C.I. Pigment Yellow 127, C.I. Pigment Yellow 128, C.I. Pigment Yellow 129, C.I. Pigment Yellow 147, C.I. Pigment Yellow 151, C.I. Pigment Yellow 154, C.I. Pigment Yellow 155, C.I. Pigment Yellow 168, C.I. Pigment Yellow 174, C.I. Pigment Yellow 175, C.I. Pigment Yellow 176, C.I. Pigment Yellow 180, C.I. Pigment Yellow 181, C.I. Pigment Yellow 185, C.I. Pigment Yellow 191, and C.I. Pigment Yellow 194.

Examples of black colorants include carbon black, and those colored black by using the aforementioned yellow, magenta, and cyan colorants in combination with magnetic materials.

These colorants can be used alone, as a mixture, or in the form of a solid solution. Colorants are selected from the viewpoint of hue angle, color saturation, lightness, lightfastness, transparency on transparent films, and dispersibility in each toner particle.

When a magnetic material is used as a colorant, the magnetic material is mainly composed of magnetic iron oxide, such as triiron tetroxide and γ-iron oxide, and may contain an element, such as phosphorus, cobalt, nickel, copper, magnesium, manganese, aluminum, and silicon. The magnetic material preferably has a BET specific surface area of 2 m²/g or more and 30 m²/g or less, more preferably 3 m²/g or more and 28 m²/g or less, as determined by a nitrogen adsorption method. In addition, the magnetic material having a Mohs hardness of 5 or more and 7 or less can be used. Examples of the shape of the magnetic material include polyhedrons, octahedrons, hexahedrons, spherical shapes, acicular shapes, and scale shapes. Shapes with less anisotropy, such as polyhedrons, octahedrons, hexahedrons, and spherical shapes, can be used from the viewpoint of increasing the image density.

The amount of the colorant added can be 1 part or more by mass and 20 parts or less by mass based on 100 parts by mass of the binder resin or a polymerizable monomer constituting the binder resin. When a magnetic powder is used, the amount thereof is preferably 20 parts or more by mass and 200 parts or less by mass, more preferably 40 parts or more by mass and 150 parts or less by mass, based on 100 parts by mass of the binder resin or the polymerizable monomer constituting the binder resin.

### External Additive

In the toner according to an embodiment of the present disclosure, an inorganic external additive or the like may be added to the toner particles as necessary within a range that does not impair the effects of the present disclosure. The inorganic external additive or the like can have a particle diameter of 1/10 or less of the weight average particle diameter of the toner particles from the viewpoint of durability when added to the toner particles. Examples of the inorganic external additive include silica, strontium titanate, fatty acid metal salts, alumina, titanium oxide, hydrotalcite compounds, and fine metal oxide particles (fine inorganic particles), such as fine zinc oxide particles, fine cerium oxide particles, and fine calcium carbonate particles. As the external additive, fine composite oxide particles containing two or more metals can be used. Two or more selected from these fine particle groups in any combination can be used. For example, fine silica particles and strontium titanate particles can be used in combination. In addition, fine resin particles and fine organic-inorganic composite particles of fine resin particles and fine inorganic particles can also be used.

The external additive may be subjected to hydrophobization treatment with a hydrophobizing agent. Examples of the hydrophobizing agent include chlorosilanes, such as methyltrichlorosilane, dimethyldichlorosilane, trimethylchlorosilane, phenyltrichlorosilane, diphenyldichlorosilane, tert-butyldimethylchlorosilane, and vinyltrichlorosilane; alkoxysilanes, such as tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, and γ-(2-aminoethyl)aminopropylmethyldimethoxysilane; silazanes, such as hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane; silicone oils, such as dimethyl silicone oil, methyl hydrogen silicone oil, methyl phenyl silicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, and terminal reactive silicone oil; siloxanes, such as hexamethylcyclotrisiloxane, octamethylcyclotetrasiloxane, decamethylcyclopentasiloxane, hexamethyldisiloxane, and octamethyltrisiloxane; and fatty acids and their metal salts, such as long-chain fatty acids, e.g., undecylic acid, lauric acid, tridecylic acid, dodecylic acid, myristic acid, palmitic acid, pentadecylic acid, stearic acid, heptadecylic acid, arachidic acid, montanic acid, oleic acid, linoleic acid, and arachidonic acid, and salts of the above fatty acids with metals, e.g., zinc, iron, magnesium, aluminum, calcium, sodium, and lithium.

Among these, alkoxysilanes, silazanes, and silicone oils can be used because they are easy to subject to hydrophobization treatment. These hydrophobizing agents may be used alone or in combination of two or more.

The external additive content can be 0.05 parts or more by mass and 20.0 parts or less by mass based on 100 parts by mass of the toner particles.

The weight average particle diameter (D4) of the toner is preferably 3.0 μm or more and 12.0 μm or less, more preferably 4.5 μm or more and 7.5 μm or less. When the weight average particle diameter (D4) is 3.0 μm or more and 12.0 μm or less, good flowability is obtained, and the latent image can be developed faithfully.

### Method for Producing Toner

An example of a method for producing the above toner particles will be described below, but the method is not limited to the following.

The method for producing the toner particles is not particularly limited. For example, a suspension polymerization method, a dissolution suspension method, an emulsion aggregation method, a pulverization method, or the like can be employed. As an example, a method for producing the toner particles by the emulsion aggregation method will be described below.

### Method for Producing Toner Particles (Toner Core Particles) by Emulsion Aggregation Method

### Step of Preparing Dispersion of Fine Resin Particles

A dispersion of fine resin particles can be prepared by any of known methods. However, a method for preparing the dispersion is not limited to these known methods. Examples thereof include an emulsion polymerization method, a self-emulsification method, the phase inversion emulsification method in which an aqueous medium is added to a solution of a resin dissolved in an organic solvent to emulsify the resin, and a forced emulsification method in which a resin is forcibly emulsified by high-temperature treatment in an aqueous medium without using an organic solvent.

As an example, a method for preparing the dispersion of fine resin particles by a phase inversion emulsification method will be described below.

A resin component is dissolved in an organic solvent that can dissolve the resin component, and a surfactant and a basic compound are added thereto. At this time, when the resin component is a crystalline resin having a melting point, the resin component may be melted by heating to a temperature equal to or higher than the melting point. Subsequently, an aqueous medium is slowly added to precipitate fine resin particles with the solution being stirred using a homogenizer or the like. Thereafter, the solvent is removed by heating or reducing pressure to prepare an aqueous dispersion of fine resin particles.

The organic solvent used to dissolve the resin component may be any organic solvent that can dissolve the resin component. Specific examples thereof include toluene and xylene.

Examples of surfactants used in the preparation step include anionic surfactants, such as sulfate salts, sulfonate salts, carboxylate salts, phosphate esters, and soaps; cationic surfactants, such as amine salts and quaternary ammonium salts; and nonionic surfactants, such as polyethylene glycols, alkylphenol ethylene oxide adducts, and polyhydric alcohols.

Examples of the basic compound used in the preparation step include inorganic bases, such as sodium hydroxide and potassium hydroxide; and organic bases, such as ammonia, triethylamine, trimethylamine, dimethylaminoethanol, and diethylaminoethanol. The basic compounds may be used alone or in combination of two or more.

### Preparation of Colorant Dispersion

The colorant dispersion can be prepared by any known dispersing method with a common dispersing device, such as a homogenizer, a ball mill, a colloid mill, or an ultrasonic disperser, without any particular limitation. Examples of a surfactant used during the dispersing operation include the surfactants described above.

### Preparation of Wax Dispersion

In the preparation of a wax dispersion, a wax is dispersed in water together with a surfactant, a basic compound, and so forth. The mixture is then heated to a temperature equal to or higher than the melting point of the wax and subjected to dispersion treatment with a homogenizer or a disperser that applies a strong shearing force. Through such treatment, the wax dispersion is obtained. Examples of the surfactant used during the dispersing operation include the surfactants described above. Examples of the basic compound used during the dispersing operation include the basic compounds described above.

The combination of the colorant particles, the binder resin particles, and the wax particles is not particularly limited and can be appropriately and freely selected in accordance with the purpose. In addition to the dispersions, another particle dispersion in which appropriately selected particles are dispersed in a dispersion medium may be further mixed. The particles contained in the other particle dispersion are not particularly limited and can be appropriately selected in accordance with the purpose, and examples thereof include internal additive particles, charge control agent particles, inorganic particles, and abrasive particles. These particles may be dispersed in the dispersion of the binder resin particles or the dispersion of the colorant particles.

Examples of a dispersant contained in the dispersion of the binder resin particles, the dispersion of the colorant particles, the wax dispersion, other particle dispersions, and so forth include aqueous media containing polar surfactants. Examples of the aqueous medium include water, such as distilled water and ion-exchanged water, and alcohols. These may be used alone or in combination of two or more. The polar surfactant content cannot be generally specified, and can be appropriately selected in accordance with the purpose.

Examples of the polar surfactant include anionic surfactants, such as sulfate salts, sulfonate salts, phosphates, and soaps; and cationic surfactants, such as amine salts and quaternary ammonium salts. Specific examples of anionic surfactants include sodium dodecylbenzenesulfonate, sodium tetradecylbenzenesulfonate, sodium dodecyl sulfate, sodium alkylnaphthalenesulfonate, and sodium dialkylsulfosuccinates. Specific examples of cationic surfactants include alkylbenzenedimethylammonium chloride, alkyltrimethylammonium chloride, and distearylammonium chloride. These may be used alone or in combination of two or more.

When sodium alkylbenzenesulfonate having an alkyl group with 12 or more and 14 or less carbon atoms is used as the polar surfactant, voids in the transfer of images with fine vertical lines in a high-temperature and high-humidity environment can be inhibited. Sodium dodecylbenzenesulfonate can be used.

These polar surfactants can also be used in combination with non-polar surfactants. Examples of non-polar surfactants include non-ionic surfactants, such as polyethylene glycol-based, alkylphenol ethylene oxide adduct-based, and polyhydric alcohol-based surfactants.

The colorant particle content can be 0.1 parts or more by mass and 30 parts or less by mass based on 100 parts by mass of the binder resin in the aggregated particle dispersion when the aggregated particles are formed.

The wax particle content is preferably 0.5 parts or more by mass and 25 parts or less by mass, more preferably 5 parts or more by mass and 20 parts or less by mass, based on 100 parts by mass of the binder resin in the aggregated particle dispersion when the aggregated particles are formed.

To more precisely control the chargeability of the toner to be obtained, the charge control particles and the binder resin particles may be added after the aggregated particles are formed.

The particle sizes of the binder resin particles, colorant particles, and other particles are measured with a laser diffraction/scattering particle size distribution analyzer LA-960V2 manufactured by Horiba, Ltd.

### Aggregated Particle Formation Step

In an aggregated particle formation step, first, the dispersion of the fine resin particles, the colorant dispersion, the wax dispersion, and so forth are mixed together to prepare a mixture. The pH is then adjusted to be an acidic region while the mixture is heated at a temperature equal to or lower than the melting point of the fine resin particles to form aggregated particles containing the fine resin particles, the colorant particles, and the release agent particles, thereby preparing a dispersion of the aggregated particles.

### First Fusion Step

In a first fusion step, under stirring conditions similar to those in the aggregated particle formation step, the pH of the aggregated particle dispersion is increased to stop the progression of aggregation, and the dispersion is heated at a temperature equal to or higher than the melting point of the resin component to prepare a dispersion of fused particles.

### Step of Attaching Fine Amorphous Resin Particles

In a step of attaching fine amorphous resin particles, a dispersion of amorphous resin particles is added to the fused-particle dispersion, and the pH is lowered to attach the amorphous resin particles to the surfaces of the fused particles, thereby preparing a dispersion of resin-attached particles. Here, this coating layer corresponds to a shell layer formed through a shell layer formation step described below. The dispersion of the fine amorphous resin particles can be prepared in accordance with the above-mentioned method for preparing the dispersion of the fine resin particles.

### Second Fusion Step

In a second fusion step, similar to the first fusion step, the pH of the dispersion of the resin-attached particles is increased to stop the progress of aggregation. The resin-attached aggregated particles are fused by heating at a temperature equal to or higher than the melting point of the resin component to prepare a toner core particle dispersion in which toner core particles each having a shell layer are dispersed.

### Method for Producing Toner Including Agglomerates

As a method for producing the toner particles including agglomerates each containing silica and the binder component, the silica and the binder component can be externally added to the toner core particles by a wet process from the viewpoint of uniformly agglomerating the silica and the binder component. As a method for producing the toner particles including agglomerates each containing silica and the binder component, the silica and the binder component can be externally added to the toner core particles by a wet process from the viewpoint of uniformly agglomerating the silica and the binder component. When a toner including agglomerates each containing the fine silica particles and the resin component is produced by the wet process, the following steps 1 and 2 can be included:
step 1: a step of preparing a toner core particle dispersion in which toner core particles are dispersed in an aqueous medium; and
step 2: a step of mixing silica and a polymerizable monomer (monomer), which will be formed into a resin component by polymerization, with the toner core particle dispersion, and polymerizing the monomer in the toner core particle dispersion to form agglomerates each containing silica and the resin on the toner core particles.

In step 1, examples of the method for preparing the toner core particle dispersion include a method in which the dispersion of the toner core particles produced in an aqueous medium is used as it is, and a method in which dry toner core particles are placed in an aqueous medium and mechanically dispersed. When the dry toner core particles are dispersed in the aqueous medium, a dispersing aid may be used.

As the dispersing aid, for example, a known dispersion stabilizer or surfactant can be used.

Specific examples of the dispersion stabilizer include the following: inorganic dispersion stabilizers, such as tricalcium phosphate, hydroxyapatite, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, and alumina; and organic dispersion stabilizers, such as polyvinyl alcohol, gelatin, methyl cellulose, methylhydroxypropyl cellulose, ethyl cellulose, sodium salt of carboxymethyl cellulose, and starch.

Examples of the surfactant include anionic surfactants, such as alkyl sulfate salts, alkylbenzene sulfonates, and fatty acid salts; nonionic surfactants, such as polyoxyethylene alkyl ethers and polyoxypropylene alkyl ethers; and cationic surfactants, such as alkylamine salts and quaternary ammonium salts.

In step 1, the solid content concentration of the toner core particle dispersion can be adjusted to 10% or more by mass and 50% or less by mass.

In step 2, the silica and the monomer to be formed into the resin component may be added as they are to the toner core particle dispersion, or a dispersion in which the silica and the monomer are dispersed in advance may be added to the toner core particle dispersion. As a method for dispersing the silica and the monomer, the dispersing aids exemplified in step 1 can be used. When particles, such as fatty acid metal salts, are mixed in addition to silica, they are mixed together with silica in step 2.

Examples of the resin component include polymers composed of monofunctional polymerizable monomers or polyfunctional polymerizable monomers, copolymers obtained by combining two or more of these, and mixtures thereof.

Examples of the polymerizable monomer include the following: styrene; styrene derivatives, such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; polymerizable acrylate monomers, such as methyl acrylate, ethyl acrylate, n-propyl acrylate, isopropyl acrylate, n-butyl acrylate, isobutyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate; polymerizable methacrylate monomers, such as methyl methacrylate, ethyl methacrylate, n-propyl methacrylate, isopropyl methacrylate, n-butyl methacrylate, isobutyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylates; vinyl esters, such as vinyl acetate, vinyl propionate, vinyl butyrate, vinyl benzoate, and vinyl formate; vinyl ethers, such as vinyl methyl ether, vinyl ethyl ether, and vinyl isobutyl ether; vinyl ketones, such as vinyl methyl ketone, vinyl hexyl ketone, and vinyl isopropyl ketone; trifunctional silane compounds each having a methacryloxyalkyl group as a substituent, such as γ-methacryloxypropyltrimethoxysilane, γ-methacryloxypropyltriethoxysilane, γ-methacryloxyoctyltrimethoxysilane, γ-methacryloxypropyldiethoxymethoxysilane, and γ-methacryloxypropylethoxydimethoxysilane; and trifunctional silane compounds each having an acryloxyalkyl group as a substituent, such as γ-acryloxypropyltrimethoxysilane, γ-acryloxypropyltriethoxysilane, γ-acryloxyoctyltrimethoxysilane, γ-acryloxypropyldiethoxymethoxysilane, and γ-acryloxypropylethoxydimethoxysilane.

Among these, trifunctional silane compounds can be used because they have a high affinity for silica. The trifunctional silane compound may be used in combination with an organosilicon compound having four reactive groups in one molecule (tetrafunctional silane), an organosilicon compound having two reactive groups in one molecule (difunctional silane), or an organosilicon compound having one reactive group (monofunctional silane). Examples thereof include the following: dimethyldiethoxysilane, tetraethoxysilane, hexamethyldisilazane, 3-aminopropyltrimethoxysilane, 3-aminopropyltriethoxysilane, 3-(2-aminoethyl)aminopropyltrimethoxysilane, 3-(2-aminoethyl)aminopropyltriethoxysilane, and trifunctional vinylsilanes, such as vinyltriisocyanatosilane, vinyltrimethoxysilane, vinyltriethoxysilane, vinyldiethoxymethoxysilane, vinylethoxydimethoxysilane, vinylethoxydihydroxysilane, vinyldimethoxyhydroxysilane, vinylethoxymethoxyhydroxysilane, and vinyldiethoxyhydroxysilane.

In step 2, silica and a monomer to be formed into the resin component are added to the toner core particle dispersion and mixed. At this time, the temperature of the toner core particle dispersion can be adjusted to a temperature suitable for the polymerization reaction. A polymerization initiator is then added while the toner core particles, silica, and the monomer are mixed to polymerize the added monomer, thereby allowing the agglomerates each containing fine silica particles and the binder component to be externally attached to the toner core particles to prepare a dispersion of toner particles.

As the polymerization initiator, any known polymerization initiator can be used without any particular restriction. Specific examples thereof include the following: peroxide-based polymerization initiators typified by hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, tert-hydroperoxide of triphenylperacetic acid, tert-butyl peroxyformate, tert-butyl peroxyacetate, tert-butyl peroxybenzoate, tert-butyl phenylperoxyacetate, tert-butyl methoxyperoxyacetate, tert-butylbenzoyl peroxide of N-(3-tolyl) peroxypalmitic acid, tert-butyl peroxy-2-ethylhexanoate, tert-butyl peroxypivalate, tert-butyl peroxyisobutyrate, tert-butyl peroxyneodecanoate, methyl ethyl ketone peroxide, diisopropyl peroxycarbonate, cumene hydroperoxide, 2,4-dichlorobenzoyl peroxide, and lauroyl peroxide; and azo- and diazo-based polymerization initiators typified by 2,2′-azobis(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile.

### Step of Forming Desired Surface Shape of Toner (Spheroidization Step)

During or after the fusing step, the toner particles can undergo a spheroidization step in which the temperature is further increased and held until a desired circularity or surface shape is achieved. A specific temperature in the spheroidization step is, for example, 90° C. or higher, preferably 92° C. or higher, and preferably 95° C. or lower. The heating time in the spheroidization step is, for example, 3 hours or more, 5 hours or more, or 8 hours or more.

### Filtration Step, Washing Step, Drying Step, Classification Step, and External Addition Step

Thereafter, a filtration step for filtering the solid content of the toner particles, a washing step, a drying step, and a classification step of adjusting the particle size, as needed, are performed to provide toner particles including agglomerates containing silica and the resin component. The toner particles may be used as a toner as they are. If necessary, the toner particles and an external additive, such as a fine inorganic powder, can be mixed and attached to each other using a mixer to provide a toner.

Methods for measuring various physical properties will be described below.

### Method for Isolating Toner Particles

A dispersion medium is prepared by adding 0.50 g of Triton-X100 (Kishida Chemical Co., Ltd.) to 100 g of ion-exchanged water.
(1) First, 1.00 g of the toner is precisely weighed in a vial. The above-mentioned dispersion medium is added to make a total of 10.00 g. The mixture is allowed to stand for 24 hours to prepare a sample liquid.
(2) The sample liquid is subjected to ultrasonic homogenizer treatment to release the external additive from the toner and disperse them in the dispersion medium. Ultrasonic treatment device: Ultrasonic homogenizer VP-050 (manufactured by Taitec Corporation)
Microtip: step-type microtip, tip diameter: 42 mm
Tip position of microchip: central portion of glass vial, at a height of 5 mm from the bottom of the vial
Ultrasonic conditions: intensity 30%, 180 minutes. During this process, ultrasonic waves are applied while the vial is cooled with ice water so as not to increase the temperature of the dispersion.
(3) The toner particles in the sample liquid are separated by suction filtration through a 10-μm membrane filter from the dispersion medium (filtrate) in which the external additive is dispersed.
(4) The toner particles after filtration were collected. The dispersion medium was added again to make a total of 10.00 g. The above steps (2) and (3) were then repeated a total of 10 times to collect the resulting toner particles. The toner particles are then sufficiently dried at 45° C. for 24 hours to isolate the toner particles.
   Method for Separating Binder Resin from Toner Particles

First, 100 mg of the toner particles are dissolved in 3 mL of chloroform. The insoluble matter is then separated by filtration with a syringe fitted with a sample treatment filter (for example, MySyori Disc H-25-2, manufactured by Tosoh Corporation) having a pore size of 0.2 μm or more and 0.5 μm or less. The soluble matter is introduced into a preparative HPLC (instrument: LC-9130 NEXT, manufactured by Nippon Analytical Industry Co., Ltd., preparative columns [60 cm], exclusion limits: 20,000 and 70,000, two connected columns), and chloroform eluent is pumped. When a peak can be detected in the resulting chromatogram, fractionation is performed at a retention time corresponding to a molecular weight of 2,000 or more of a monodisperse polystyrene standard sample.

The solution of the resulting fraction is evaporated to dryness, thereby separating the binder resin from the release agent.

### Composition Analysis of Binder Resin Composed of Multiple Components

The chloroform-soluble matter of the separated binder resin is used as a specimen. Regarding the sample, the concentration of the binder resin is adjusted to 0.1% by mass with chloroform. The solution is filtered through a 0.45-μm PTFE filter and used for measurement. The gradient polymer LC measurement conditions are described below.
Instrument: Ultimate 3000 (manufactured by Thermo Fisher Scientific)
Mobile phase A: chloroform (HPLC), Mobile phase B: acetonitrile (HPLC)
Gradient: 2 min (A/B=0/100)→25 min (A/B=100/0)

The gradient of the change in mobile phase is adjusted to be linear.
Flow rate: 1.0 mL/min
Injection: 0.1% by mass×20 μL
Column: Tosoh TSKgel ODS (+4.6 mm×150 mm×5 μm)
Column temperature: 40° C.
Detector: Corona Charged Particle Detector (Corona-CAD, manufactured by Thermo Fisher Scientific)

The polyester A is fractionated at the time corresponding to the polyester A. The crystalline polyester is fractionated at the time corresponding to the crystalline polyester. In the fractionation, a required amount of each chloroform/acetonitrile solution is collected, evaporated, and concentrated to give samples of the polyester A (resin A) and the crystalline polyester (resin B).

Samples of the resin A component and the resin B component are used to determine the composition ratio and mass ratio by nuclear magnetic resonance (NMR) spectroscopy as described below.

To 20 mg of each of the samples of resin component A and resin component B, 1 mL of deuterated chloroform is added. The proton NMR spectrum of each dissolved resin is measured. From the resulting NMR spectrum, the mole ratio and the mass ratio of each monomer can be calculated by assuming that the minimum unit disposed between ester bonds is a structure derived from a monomer, and the proportion of each monomer unit can be determined. For example, in the case of a styrene-acrylic copolymer, the composition ratio and the mass ratio can be calculated based on the peak at about 6.5 ppm originating from the styrene monomer and the peak at about 3.5 to 4.0 ppm originating from the acrylic monomer.

For nuclear magnetic resonance (NMR) spectroscopy, the following instrument and measurement conditions can be used.
NMR instrument: Resonance ECX500, manufactured by JEOL Ltd.
Observed nucleus: proton
Measurement mode: single pulse
   Method for Quantitatively Determining Uᵢₛₒ, U_{EO}, and U_{PO} in Polyester a by NMR Measurement

The identification of the components of the polyester A and the determination of the mole ratio and the mass ratio by nuclear magnetic resonance (NMR) spectroscopy are described below.

To 20 mg of the resulting polyester A, 1 mL of deuterated chloroform is added. The proton NMR spectrum of the dissolved polyester A is measured. From the resulting NMR spectrum, the minimum unit disposed between ester bonds is regarded as a structure derived from a monomer, and the mole ratio and mass ratio of each monomer are calculated.

For example, the composition ratio and mass ratio can be calculated based on the following peaks (chemical shift value and number of protons).
Unit derived from isophthalic acid: 7.5 ppm (1), 8.2 ppm (2), 8.7 ppm (1)
Unit derived from terephthalic acid: 8.1 ppm (4)
Unit derived from ethylene oxide adduct of bisphenol A: 1.6 ppm (6), 4.3 ppm (4), 4.7 ppm (4), 6.8 ppm (4), 7.1 ppm (4)
Unit derived from propylene oxide adduct of bisphenol A: 1.5 ppm (6), 1.6 ppm (6), 4.1 ppm (4), 5.5 ppm (2), 6.8 ppm (4), 7.1 ppm (4)
Unit derived from ethylene glycol: 4.3 ppm (4)
NMR instrument: JEOL Resonance ECX500
Observed nucleus: proton
Measurement mode: single pulse
Reference peak: TMS

The proportion (mol %) of the unit Uᵢₛₒ derived from isophthalic acid based on all units derived from acid components is determined by NMR analysis. The total proportion (mol %) of U_{EO} and U_{PO} is calculated based on all units derived from alcohol components. The proportion of U_{EO} (mol %) based on the sum of the proportion of U_{EO} and the proportion of U_{PO} is calculated.

### Method for Measuring Weight-Average Molecular Weight Mw and Number-Average Molecular Weight Mn

The molecular weight of a sample, such as the polyester A, the crystalline polyester, or the styrene-acrylic resin, is measured by gel permeation chromatography (GPC) as described below.

The sample is dissolved in tetrahydrofuran (THF). In the case of the polyester A or the styrene-acrylic resin, the sample is dissolved in THF at room temperature over 24 hours. In the case of the crystalline polyester, THF is heated to 40° C. to dissolve the sample, and the mixture is then allowed to stand for 24 hours.

Each solution in which the sample has been dissolved is filtered through a solvent-resistant membrane filter (“MySyori Disc”, manufactured by Tosoh Corporation) with a pore size of 0.2 μm to prepare a sample solution. The sample solution is prepared in such a manner that the concentration of the THF-soluble matter is 0.8% by mass. Using this sample solution, measurements are performed under the following conditions.
Instrument: HLC8120 GPC (detector: RI) (manufactured by Tosoh Corporation)
Column: a series of seven Shodex KF-801, 802, 803, 804, 805, 806, and 807 columns (manufactured by Showa Denko K.K.)
Eluent: tetrahydrofuran (THF)
Flow rate: 1.0 mL/min
Oven temperature: 40.0° C.
Sample injection volume: 0.10 mL

Upon calculation of the molecular weight of the sample, a molecular weight calibration curve prepared with standard polystyrene resins, such as trade name “TSK Standard Polystyrene F-850, F-450, F-288, F-128, F-80, F-40, F-20, F-10, F-4, F-2, F-1, A-5000, A-2500, A-1000, and A-500” manufactured by Tosoh Corporation, is used.

### Method for Quantitatively Determining Aluminum Element in Toner Particle

The measurement of the fluorescent X-rays of aluminum element conforms to JIS K 0119-1969, and is specifically described below.

As a measuring instrument, a wavelength-dispersive X-ray fluorescence analyzer (Model: Axios, manufactured by PANalytical) and bundled dedicated software (Model: SuperQ ver. 4.0F, manufactured by PANalytical) for setting measurement conditions and analyzing measurement data are used. The anode of an X-ray tube is composed of Rh. The measurement atmosphere is a vacuum. The measurement diameter (collimator mask diameter) is 27 mm. The measurement time is 10 seconds. A proportional counter (PC) is used for detection.

A pellet having a thickness of about 2 mm and a diameter of about 39 mm is used as specimen for measurement, the pellet being formed by charging about 4 g of the toner particles into a special aluminum ring for pressing, leveling the surface of the toner, and compressing the toner particles with a tablet compression machine (Model: BRE-32, manufactured by Maekawa Testing Machine Mfg. Co., Ltd.) at 20 MPa for 60 seconds.

The acceleration voltage and the current value of the X-ray generator are 24 kV and 160 mA, respectively, for the measurement. The element is identified based on the peak position of the X-ray beam obtained. The concentration is calculated from the count rate (unit: cps), which is the number of X-ray photons per unit time.

### Method for Measuring Weight Average Particle Diameter (D4) and Number Average Particle Diameter (D1)

The weight average particle diameter (D4) and the number average particle diameter (D1) of the toner are calculated as follows: As a measuring instrument, a precision particle size distribution measuring instrument “Coulter Counter Multisizer 3” (registered trademark, manufactured by Beckman Coulter) that includes an aperture tube of 100 μm and that is based on an aperture impedance method is used. For setting the measurement conditions and analyzing measurement data, attached dedicated software “Beckman Coulter Multisizer 3 Version 3.51” (manufactured by Beckman Coulter) is used. The measurement is performed by 25,000 effective measurement channels.

As an aqueous electrolyte solution used for the measurement, an aqueous electrolyte solution prepared by dissolving special-grade sodium chloride in ion-exchanged water to have a concentration of about 1% by mass, for example, “ISOTON II” (manufactured by Beckman Coulter) can be used.

Before the measurement and the analysis, the dedicated software was set as described below.

On the screen “Change standard measurement method (SOMME)” of the dedicated software, the total count in the control mode is set to 50,000 particles, the number of measurements is set to one, and a value obtained by using “Standard particles of 10.0 μm” (manufactured by Beckman Coulter) is set as a Kd value. A threshold value and a noise level are automatically set by pressing the “Threshold/noise level measurement button”. The current is set to 1,600 μA, the gain is set to 2, the electrolytic solution is set to ISOTON II, and “Flush aperture tube after measurement” is checked.

On the “Conversion setting from pulse to particle size” screen of the dedicated software, the bin interval is set to logarithmic particle size, the particle size bin is set to 256 particle size bin, and the particle size range is set to 2 μm or more and 60 μm or less.

The specific measurement method is described below.
(1) About 200 mL of the aqueous electrolyte solution is placed in a 250-mL round-bottom glass beaker made exclusively for Multisizer 3. The beaker is placed on a sample stand. The stirring is performed with a stirrer rod in a counterclockwise direction at 24 revolutions per second. The “Aperture flush” function of the dedicated software is performed to remove dirt and air bubbles in the aperture tube.
(2) About 30 mL of the aqueous electrolyte solution is placed in a 100-mL flat-bottom glass beaker. About 0.3 mL of the diluted solution of Contaminon N (a 10% by mass aqueous solution of a neutral detergent for cleaning a precision measuring instrument, the solution having a pH of 7 and containing a nonionic surfactant, an anionic surfactant, and an organic builder, manufactured by Wako Pure Chemical Industries, Ltd.) diluted three times by mass with ion-exchanged water is added as a dispersant.
(3) An ultrasonic disperser (Ultrasonic Dispension System Tetora 150 manufactured by Nikkaki Bios Co., Ltd.) is provided, the disperser having an electrical output of 120 W and including two built-in oscillators having an oscillation frequency of 50 kHz with their phases shifted by 180° from each other. About 3.3 L of ion-exchanged water is placed in the water tank of the ultrasonic disperser, and about 2 mL of Contaminon N is added to this water tank.
(4) The beaker described in (2) is placed in a beaker-fixing hole of the ultrasonic disperser, and then the ultrasonic disperser is operated. The height position of the beaker is adjusted in such a manner that the resonance state of the liquid surface of the aqueous electrolyte solution in the beaker is maximized.
(5) About 10 mg of the toner is added little by little to the aqueous electrolyte solution and dispersed while the aqueous electrolyte solution in the beaker described in (4) is irradiated with ultrasonic waves. The ultrasonic dispersion treatment is continued for another 60 seconds. During the ultrasonic dispersion, the water temperature in the water tank is appropriately adjusted to 10° C. or higher and 40° C. or lower.
(6) The aqueous electrolyte solution, described in (5), in which the toner has been dispersed is added dropwise using a pipette into the round-bottom beaker, described in (1), placed on the sample stand. The measurement concentration is adjusted to about 5%. The measurement is continued until the number of particles measured reaches 50,000.
(7) The measurement data is analyzed using the dedicated software provided with the apparatus to calculate the weight average particle diameter (D4) and the number average particle diameter (D1). When the dedicated software is set to Graph/volume %, the “Average diameter” on the Analysis/volume statistics (Arithmetic mean) screen is the weight average particle diameter (D4). When the dedicated software is set to Graph/number %, the “Average diameter” on the Analysis/number statistics (Arithmetic mean) screen is the number average particle diameter (D1).

### Method for Acquiring Backscattered Electron Image of Toner Surface

The percentage of the toner base exposed is calculated using a backscattered electron image of the surfaces of the toner particles.

The backscattered electron image of the toner surface is obtained with a scanning electron microscope (SEM).

A backscattered electron image obtained from an SEM is also called a “composition image”. Elements with smaller atomic numbers are detected as darker areas, while elements with larger atomic numbers are detected as brighter areas.

Typically, toner particles are resin particles, each mainly containing a carbon-based composition that contains, for example, a resin component and a release agent. When silica and a metal oxide are present on the surfaces of the toner particles, the silica and the metal oxide are observed as bright areas, and the resin portions mainly composed of carbon are observed as dark areas in a backscattered electron image obtained from SEM.

The SEM instrument and observation conditions are described below.
Instrument used: ULTRA PLUS manufactured by Carl Zeiss Microscopy GmbH
Acceleration voltage: 1.0 kV
WD: 2.0 mm
Aperture size: 30.0 μm
Detection signal: EsB (energy selective backscattered electron)
EsB grid: 800 V
Observation magnification: 50,000×
Contrast: 63.0±5.0% (reference value)
Brightness: 38.0±5.0% (reference value)
Resolution: 1024×768
Pretreatment: Toner particles are dispersed on a carbon tape (no vapor deposition)

Contrast and brightness are set, as appropriate, according to the state of the instrument used. The acceleration voltage and EsB grid are set so as to achieve items, such as acquisition of structural information on the outermost surface of each toner particle, prevention of charge-up of the non-vapor-deposited sample, and selective detection of high-energy backscattered electrons. The observation field of view is selected near the vertex where the curvature of the toner particle is the smallest.

Method to Verify that Dark Area in Backscattered Electron Image Originate from Carbon Atom

The fact that the dark areas in the observed backscattered electron image originate from the resin is verified by superimposing the backscattered electron image on an elemental mapping image that can be obtained by energy-dispersive X-ray analysis (EDS) of a scanning electron microscope (SEM).

The SEM/EDS instruments and observation conditions are described below.
Instrument used (SEM): ULTRA PLUS manufactured by Carl Zeiss Microscopy GmbH
Instrument used (EDS): NORAN System 7, Ultra Dry EDS Detector, manufactured by Thermo Fisher Scientific.
Acceleration voltage: 5.0 kV
WD: 7.0 mm
Aperture size: 30.0 μm
Detection signal: SE2 (secondary electron)
Observation magnification: 50,000×
Mode: spectral imaging
Pretreatment: Toner particles are dispersed on a carbon tape and coated with platinum by sputtering.

The elemental mapping image obtained by this method is superimposed on the backscattered electron image described above to verify that the carbon atom areas in the mapping image match the dark areas in the backscattered electron image.

### Method to Verify Dispersed State of Resin Component Contained in Agglomerate

The dispersed state of the resin component contained in the agglomerates is calculated using a backscattered electron image of the agglomerates on the toner surface. The backscattered electron image of the agglomerates on the toner surface is obtained in the same manner as in the case of obtaining a backscattered electron image of the toner surface.

The dispersed state of the resin component contained in the agglomerates is calculated from the obtained backscattered electron image using image processing software ImageJ (developed by Wayne Rasband). The procedure is described below.

From “Type” in the Image menu, the backscattered electron image for analysis is converted to 8 bits. From “Filters” in the Process menu, the median diameter is set to 2.0 pixels to reduce image noise. The center of the image is estimated, excluding the observation condition display section displayed at the bottom of the backscattered electron image. Then a 1.5-μm square area centered on the image center of the backscattered electron image is selected using “Rectangle Tool” on the toolbar.

“Threshold” is then selected from “Adjust” in the Image menu. The total pixels corresponding to brightness B1 are selected in manual operation, and “Apply” is clicked to obtain a binarized image. This operation displays pixels corresponding to A1 in black (pixel group A1) and pixels corresponding to A2 in white (pixel group A2). The center of the image is estimated again, excluding the observation condition display section displayed at the bottom of the backscattered electron image. Then, a 1.5-μm square area centered on the image center of the backscattered electron image is selected using the Rectangle Tool on the toolbar.

Using the “Straight Line” tool on the toolbar, the scale bar is selected in the observation condition display section displayed at the bottom of the backscattered electron image. When “Set Scale” is selected in the Analyze menu under these conditions, a new window is opened, and the straight-line pixel distance selected in the “Distance in Pixels” column is entered.

The previous scale bar value, such as 100, is entered in the “Known Distance” column of this window, the unit of this scale bar, such as nm, is entered in the “Unit of Measurement” column, and OK is clicked to complete the scale settings.

“Set Measurements” is then selected in the Analyze menu, and “Area” and “Feret's diameter” are checked. “Analyze Particles” is selected in the Analyze menu. “Display Result” is checked, and OK is clicked to perform domain analysis.

The resulting analysis image is subjected to “Erode” processing for 10 pixels and then “Dilate” processing for 10 pixels, using ImageJ. The “Erode” processing and “Dilate” processing are carried out from the “Binary” item in the Process menu. FIG. 2 illustrates an example of an image obtained by performing the above processing.

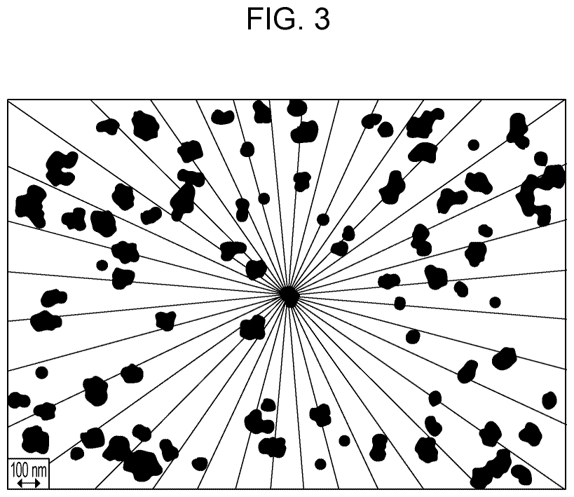

After the above processing, the “Straight Line” tool on the toolbar is used on the resulting analysis image. The midpoint of the analysis image is set as the reference point, and 18 straight lines are drawn at intervals of 10°, the straight lines passing through the reference point from one edge of the image to the opposite edge. FIG. 3 illustrates an example of the image with the line segments drawn.

The length L of each line segment located over the continuous bright area in the image is measured. The number of straight lines containing line segments with a length L of 100 nm or more is counted to verify whether the number of straight lines with such segments in the agglomerate is 12 or more.

Method for Determining Proportion of Toner Particle Including Agglomerate with 12 or More Straight Lines

The above procedure is performed for 30 toner particles including agglomerates contained in the toner to be evaluated. The number of toner particles including agglomerates with 12 or more straight lines is counted. The proportion A of the toner particles including agglomerates with 12 or more straight lines is calculated from the following formula.

A=[(number of toner particles including agglomerates having 12 or more straight lines)/30]

### Method for Determining Area Fraction of Resin Component Contained in Agglomerate

The area fraction of the resin component is calculated based on the domain D1 of the resin component and the domain D2 of the non-resin component, using a backscattered electron image of the agglomerates on the toner surface. The backscattered electron image of the agglomerates on the toner surface is obtained in the same manner as in the case of obtaining a backscattered electron image of the toner surface.

The domains D1 and D2 are analyzed by using the backscattered electron image of the outermost surface of the toner particle obtained by the above-mentioned method, with the image processing software ImageJ (developed by Wayne Rasband). The procedure is described below.

From “Type” in the Image menu, the backscattered electron image for analysis is converted to 8 bits. From “Filters” in the Process menu, the median diameter is set to 2.0 pixels to reduce image noise. The center of the image is estimated, excluding the observation condition display section displayed at the bottom of the backscattered electron image. Then a 1.5-μm square area centered on the image center of the backscattered electron image is selected using “Rectangle Tool” on the toolbar.

The “Freehand selections” function in the Image menu is used to select only the portion where the carbon atom portion of the mapping image and the dark portion of the backscattered electron image match, and the selected portion is entirely filled with black. In addition, all areas other than the portion where the carbon atom portion of the mapping image and the dark portion of the backscattered electron image match are filled with white. Then “Threshold” is selected from “Adjust”. In manual operation, 128, which is the middle gray level between black and white in an 8-bit image, is selected as the threshold, and “Apply” is clicked to obtain a binarized image.

This operation displays the pixels corresponding to domain D1 (resin component) in black (pixel group A1) and the pixels corresponding to domain D2 (other than the resin component) in white (pixel group A2).

The center of the image is estimated again, excluding the observation condition display section displayed at the bottom of the backscattered electron image. Then, a 1.5-μm square area centered on the image center of the backscattered electron image is selected using the Rectangle Tool on the toolbar.

Using the “Straight Line” tool on the toolbar, the scale bar is selected in the observation condition display section displayed at the bottom of the backscattered electron image. When “Set Scale” is selected in the Analyze menu under these conditions, a new window is opened, and the straight-line pixel distance selected in the “Distance in Pixels” column is entered.

The previous scale bar value, such as 100, is entered in the “Known Distance” column of this window, the unit of this scale bar, such as nm, is entered in the “Unit of Measurement” column, and OK is clicked to complete the scale settings.

“Set Measurements” is then selected in the Analyze menu, and “Area” and “Feret's diameter” are checked. “Analyze Particles” is selected in the Analyze menu. “Display Result” is checked, and OK is clicked to perform domain analysis.

From the newly opened “Results” window, the area (“Area”) for each domain corresponding to the domain D1 formed of the pixel group A1 and the domain D2 formed of the pixel group A2 is acquired.

The total area of the resin component domain D1 is denoted by S1 (μm²), and the total area of the non-resin component domain D2 is denoted by S2 (μm²). The area fraction S of the resin component is calculated from the obtained S1 and S2 using the following formula:

$$S ( area \% ) = [ S 1 / ( S 1 + S 2 ) ] \times 100$$

The above procedure is performed for 10 fields of view for the toner particles to be evaluated, and the arithmetic mean value is used as the area fraction of the resin component.

### Method for Observing Toner and Calculating Number of Toner Particles

The toner is observed with a scanning electron microscope (SEM). The
SEM instrument and observation conditions are described below.
Instrument used: ULTRA PLUS manufactured by Carl Zeiss Microscopy GmbH
Acceleration voltage: 1.0 kV
WD: 2.0 mm
Aperture Size: 30.0 μm
Detection signal: SE2 (secondary electron)
Observation magnification: 2,000×
Contrast: 45.0±5.0% (reference value)
Brightness: 38.0±5.0% (reference value)
Resolution: 1024×768
Pretreatment: Toner particles are dispersed on carbon tape (no vapor deposition)

Contrast and brightness are set, as appropriate, according to the state of the instrument used. The acceleration voltage is set so as to achieve items, such as acquisition of structural information on the outermost surface of each toner particle, and prevention of charge-up of the non-vapor-deposited sample.

With regard to the number of observation fields of view, the number of toner particles each having a shape that falls entirely within the observation field of view in the obtained secondary electron image is counted and denoted as Tall (pieces). Observation is continued until Tall reaches 300 or more.

### Method for Calculating Percentage by Number CI of Toner Particles Including Agglomerates

In all the secondary electron images obtained from the fields of view in the above observation, the number of toner particles including agglomerates among the toner particles each having a shape that falls entirely within the observation field of view is counted and denoted as Tagg (pieces). For the toner including the agglomerates, the number of toner particles as presented in FIG. 1 is counted.

From the obtained Tall (pieces) and Tagg (pieces), CI (% by number) is calculated using the following formula.

$$CI ( \% by number ) = Tagg / Tall \times 100$$

### Method for Measuring Agglomerate Size and Method for Counting Toner Including Agglomerate

In the above-described scanning electron microscope observation, images of the entire toner are captured at an appropriate magnification (5k to 10k) and stored. The image resolution is 1024×768 pixels.

From the obtained SEM image, an area determined to be an agglomerate is selected on the image using image analysis software ImageJ (developed by Wayne Rasband). The size of the agglomerate is defined by the maximum Feret's diameter of this selected area. The calculation procedure is described below.
(1) The scale is set by selecting [Analyze]-[Set Scale].
(2) [Analyze]-[Set Measurements]-[Feret's diameter] is checked.
(3) [Freehand Selections] is selected, and the agglomerate on the image is manually selected.
(4) [Analyze]-[Measure] is selected, and the maximum Feret's diameter (Feret) of the selected area is obtained.
(5) When there are multiple agglomerates in the image, steps (3) and (4) are repeated.
(6) The same analysis is performed on other images of the observed toner including agglomerates each having a maximum Feret's diameter of 500 nm or more and 8,000 nm or less.
(7) The maximum value of the Feret's diameter in the obtained analysis results is defined as the maximum Feret's diameter.

The agglomerates are defined as those having a maximum Feret's diameter of 500 nm or more and 8,000 nm or less.

The toner is freely observed with a scanning electron microscope, and the arithmetic mean value of the maximum Feret's diameter of a total of 100 agglomerates is defined as Ag. Moreover, the percentage by number of the toner particles including agglomerates among the freely-observed toner particles is defined as CI.

### Method for Evaluating Whether Agglomerate Contain Silica Particles and Resin Component

The presence of fine silica particles and a resin component in each agglomerate is verified using STEM-EDX and a scanning electron microscope.

For toner including agglomerates, the sectional structure and composition of each agglomerate are evaluated using STEM-EDX.

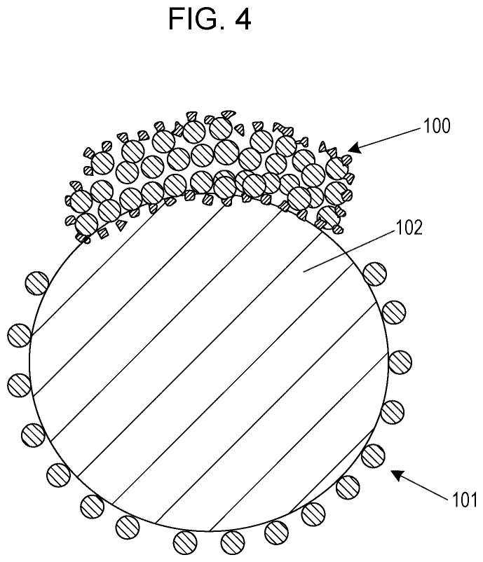

An osmium plasma coater (OPC80T, Filgen Inc.) is used to deposit an Os film (5 nm) and a naphthalene film (20 nm) on the toner as protective films. The toner is embedded in a photocurable resin (D800, JEOL Ltd.). Using an ultrasonic ultramicrotome (UC7, Leica), a section of the toner particle having a thickness of 100 nm is formed at a cutting speed of 1 mm/s. At this time, a plurality of toner particles may be collectively processed to prepare the sections of 300 to 500 toner particles. FIG. 4 is a schematic sectional view of a toner including an agglomerate. In FIG. 4, reference numeral 100 denotes an agglomerate, reference numeral 101 denotes an external additive, and reference numeral 102 denotes a toner particle (toner base particle).

The obtained section is subjected to STEM-EDX observation using the STEM function of TEM-EDX (TEM: JEOL JEM2800 (200 keV), EDX detector: JEOL Dry SD 100GV, EDX system: Thermo Fisher NORAN SYSTEM 7). The STEM probe size is 1.0 nm.

The magnification is 50k to 300k. The EDX image size is 256×256 pixels. The storage rate is adjusted to 10,000 cps. Acquisition is performed by accumulating 50 frames. The field of view is set in such a manner that the agglomerate present on the outer circumferential portion of the toner particle is included in the observation location.

The presence of the resin component and the particles mainly composed of silica in the agglomerate can be determined by checking for separate areas where silicon and oxygen are abundant and areas where an element derived from the resin component is abundant in the same region. When a resin is used as the resin component, carbon is abundant.

A backscattered electron image of the toner including agglomerates is observed with a scanning electron microscope. The image capturing conditions are described below.

### (1) Sample Preparation

Carbon tape is attached to a sample stage (aluminum sample stage, 12.5 mm×6 mm in thickness) and the toner is placed on top. The excess sample is removed from the sample stage by air blowing. The sample stage is placed on a sample holder, and then the sample holder is placed in the scanning electron microscope (Zeiss Ultra Plus).

### (2) Setting of Electron Microscope Observation Conditions

The presence of agglomerate containing fine silica particles and a resin component is verified using an image obtained through backscattered electron image observation with Ultra Plus. Since the image contrast changes in accordance with the elemental composition in the backscattered electron image, it is possible to determine the presence of silica and the binder component in the agglomerate. The acceleration voltage is 0.7 kV, the ECB Grid is 500 V, and the WD is 3.0 mm.

### (3) Focus Adjustment

The observation magnification is set to 30,000× (30k), and “Alignment” and “Stigma” are adjusted. The field of view is adjusted at an appropriate observation magnification to an area having a form that seems to be the agglomerate. From the resulting backscattered electron image, the agglomerate can be determined to be the same as the agglomerate whose composition has been observed by STEM-EDX based on the presence of two types of contrast, one of which seems to correspond to silica and the other seems to be the binder component.

Method for Calculating Percentages by Number Ca and Cb of Toner Particles Including Agglomerates when Ultrasonic Treatment is Performed

About 10 mL of ion-exchanged water from which solid impurities and so forth have been removed is placed in a glass container.

About 0.5 mL of the diluted solution of Contaminon N (a 10% by mass aqueous solution of a neutral detergent for cleaning a precision measuring instrument, the solution having a pH of 7 and containing a nonionic surfactant, an anionic surfactant, and an organic builder, manufactured by Wako Pure Chemical Industries, Ltd.) diluted three times by mass with ion-exchanged water is added thereto as a dispersant. About 0.02 g of a sample to be measured is added thereto. The mixture is subjected to the following dispersion treatment with stirring using an ultrasonic disperser. At this time, the dispersion is appropriately cooled in such a manner that the temperature of the dispersion is 10° C. or higher and 40° C. or lower. As the ultrasonic disperser, an ultrasonic homogenizer (“VP-050”, manufactured by Taitec Corporation) with an oscillation frequency of 30 kHz is used. A vibrating unit is immersed 1.0 cm deep in the dispersion and is vibrated under ultrasonic condition A or ultrasonic condition B.
Ultrasonic condition A: output frequency: 30 kHz, output capacity: 0.75 W, and irradiation time 300 seconds
Ultrasonic condition B: output frequency: 30 kHz, output capacity: 25 W, and irradiation time: 300 seconds

The dispersion prepared in the above procedure is filtered using Kiriyama filter paper (No. 5C: pore size: 1 μm) to separate the particles and the filtrate. The resulting particles are washed with 100 parts by mass of ion-exchanged water and vacuum-dried at 25° C. for 24 hours to give a powder for use in measuring the percentages by number Ca and Cb of toner particles including agglomerates.

Ca and Cb of the resulting powder are calculated in the same manner as in the “Method for Calculating Percentage by Number CI of Toner Particles Including Agglomerates”, and it is checked whether the following relationships of expressions (1) and (2) are satisfied.

$$0.9 \leq Ca / CI \leq 1. \qquad expression ( 1 )$$

$$0.1 \leq Cb / CI \leq 0.4 \qquad expression ( 2 )$$

Method for Isolating Binder Resin from Toner Particle
Method for Separating Binder Resin from Toner Particle

First, 100 mg of the toner particles are dissolved in 3 mL of chloroform. The insoluble matter is then separated by filtration with a syringe fitted with a sample treatment filter (for example, MySyori Disc H-25-2, manufactured by Tosoh Corporation) having a pore size of 0.2 μm or more and 0.5 μm or less. The soluble matter is introduced into a preparative HPLC (instrument: LC-9130 NEXT, manufactured by Nippon Analytical Industry Co., Ltd., preparative columns [60 cm], exclusion limits: 20,000 and 70,000, two connected columns), and chloroform eluent is pumped. When a peak can be detected in the resulting chromatogram, fractionation is performed at a retention time corresponding to a molecular weight of 2,000 or more of a monodisperse polystyrene standard sample.

The solution of the resulting fraction is evaporated to dryness, thereby separating the binder resin from the release agent.

### Composition Analysis of Polyester A and Crystalline Polyester

The chloroform-soluble matter of the separated binder resin is used as a specimen. Regarding the sample, the concentration of the binder resin is adjusted to 0.1% by mass with chloroform. The solution is filtered through a 0.45-μm PTFE filter and used for measurement. The gradient polymer LC measurement conditions are described below.
Instrument: Ultimate 3000 (manufactured by Thermo Fisher Scientific)
Mobile phase A: chloroform (HPLC), Mobile phase B: acetonitrile (HPLC)
Gradient: 2 min (A/B=0/100)→25 min (A/B=100/0)

The gradient of the change in mobile phase is adjusted to be linear.
Flow rate: 1.0 mL/min
Injection: 0.1% by mass×20 μL
Column: Tosoh TSKgel ODS (+4.6 mm×150 mm×5 μm)
Column temperature: 40° C.
Detector: Corona Charged Particle Detector (Corona-CAD, manufactured by Thermo Fisher Scientific)

The polyester A is fractionated at the time corresponding to polyester A (7 minutes to 9 minutes). The crystalline polyester is fractionated at the time (13 minutes to 15 minutes) corresponding to the crystalline polyester.

In the fractionation, a required amount of each chloroform/acetonitrile solution is collected, evaporated, and concentrated to give samples of the polyester A and the crystalline polyester.

Samples of the polyester A component and the crystalline polyester component are used to determine the composition ratio and mass ratio by nuclear magnetic resonance (NMR) spectroscopy as described below.

To 20 mg of each of the samples of the polyester component A and the crystalline polyester component, 1 mL of deuterated chloroform is added. The proton NMR spectrum of each dissolved resin is measured. From the resulting NMR spectrum, the mole ratio and the mass ratio of each monomer can be calculated by assuming that the minimum unit disposed between ester bonds is a structure derived from a monomer, and the proportion of each monomer unit can be determined.

For nuclear magnetic resonance (NMR) spectroscopy, the following instrument and measurement conditions can be used.
NMR instrument: Resonance ECX500, manufactured by JEOL Ltd.
Observed nucleus: proton
Measurement mode: single pulse
   Method for Quantitatively Determining Uᵢₛₒ, U_{EO}, and U_{PO} in Polyester a by NMR Measurement

### Identification of Component of Polyester a and Determination of Mole Ratio and Mass Ratio by Nuclear Magnetic Resonance (NMR) Spectroscopy

To 20 mg of the resulting polyester A, 1 mL of deuterated chloroform is added. The proton NMR spectrum of the dissolved polyester A is measured. From the resulting NMR spectrum, the minimum unit disposed between ester bonds is regarded as a structure derived from a monomer, and the mole ratio and mass ratio of each monomer are calculated.

For example, the composition ratio and mass ratio can be calculated based on the following peaks (chemical shift value and number of protons).
Unit derived from isophthalic acid: 7.5 ppm (1), 8.2 ppm (2), 8.7 ppm (1)
Unit derived from terephthalic acid: 8.1 ppm (4)
Unit derived from ethylene oxide adduct of bisphenol A: 1.6 ppm (6), 4.3 ppm (4), 4.7 ppm (4), 6.8 ppm (4), 7.1 ppm (4)
Unit derived from propylene oxide adduct of bisphenol A: 1.5 ppm (6), 1.6 ppm (6), 4.1 ppm (4), 5.5 ppm (2), 6.8 ppm (4), 7.1 ppm (4)
Unit derived from ethylene glycol: 4.3 ppm (4)
NMR instrument: JEOL Resonance ECX500
Observed nucleus: proton
Measurement mode: single pulse
Reference peak: TMS

The proportion (mol %) of the unit Uᵢₛₒ derived from isophthalic acid based on all units derived from acid components is determined by NMR analysis. The total proportion (mol %) of U_{EO} and U_{PO} is calculated based on all units derived from alcohol components. The proportion of U_{EO} (mol %) based on the sum of the proportion of U_{EO} and the proportion of U_{PO} is calculated.

### Method for Measuring Average Circularity of Toner (Particles)

The average circularity of the toner or the toner particles is measured with an “FPIA-3000” flow type particle image analyzer (manufactured by Sysmex Corporation) under the measurement and analysis conditions for calibration operations.

An appropriate amount of a surfactant, alkylbenzene sulfonate, as a dispersant is added to 20 mL of ion-exchanged water, followed by the addition of 0.02 g of a measurement sample. The mixture is subjected to dispersion treatment for 2 minutes with a desktop ultrasonic cleaner disperser (trade name: VS-150, manufactured by Velvo-Clear Co., Ltd.) at an oscillation frequency of 50 kHz and an electrical output of 150 W, preparing a dispersion for measurement. At this time, the dispersion is appropriately cooled in such a manner that the temperature of the dispersion is 10° C. or higher and 40° C. or lower.

The flow type particle image analyzer equipped with a standard objective lens (10×) is used for measurement. Particle sheath “PSE-900A” (manufactured by Sysmex Corporation) is used as a sheath liquid. The dispersion prepared according to the above procedure is introduced into the flow type particle image analyzer, and 3000 toner particles are measured in a total count mode and an HPF measurement mode. The binarization threshold at the time of particle analysis is set to 85%. The diameter of the analyzed particle is limited to an equivalent circle diameter of 1.98 μm or more and 19.92 μm or less. Thereby, the average circularity of the toner (particles) is determined.

In the measurement, automatic focus adjustment is performed using standard latex particles (for example, 5100A (trade name) manufactured by Duke Scientific Corporation) diluted with ion-exchanged water) before the start of measurement. After that, focus adjustment can be performed every 2 hours from the start of measurement.

### Determination of Presence or Absence of Dodecylbenzenesulfonic Acid or Dodecylbenzenesulfonate in Toner

The presence or absence of dodecylbenzenesulfonic acid or dodecylbenzenesulfonate is determined by an analysis using an MS/MS (mass-mass) method with a tandem mass spectrometer directly connected to a liquid chromatograph ESI/MS analyzer.

The MS/MS method is a mass spectrometry method in which fragments extracted in a first analysis system are measured in a second analysis system, so that fragments with smaller molecular weights can be detected, and structural analysis of the sample can be easily performed.

Elution condition A: At 25° C., methanol (JIS K 8891 standard equivalent) in an amount of 10 times the toner on a mass basis is used, and then the mixture is stirred with a stirrer for 10 hours at a rotor speed of 200 rpm.

Centrifugal separation condition A: Rotation is performed at a rotation radius of 10.1 cm and a rotation speed of 3,500 rpm for 30 minutes at 25° C.

The toner is treated under the elution condition A to prepare a sample. The sample is separated into a solid component and a supernatant liquid under the centrifugal separation condition A.

The supernatant liquid obtained by the above preparation is supplied to the following measuring instrument, and is subjected to a liquid chromatography ESI/MS analysis under the following analysis condition B. A mass spectrum of the anion is obtained, and the detection of a peak at m/z=325 is confirmed. The ion detected as a peak at m/z=325 is used as a precursor ion and supplied to the tandem mass spectrometer to obtain an MS/MS spectrum under the conditions of analysis condition B.
Measuring instrument: Ultimate3000 (manufactured by Thermo Fisher Scientific)
Mass spectrometer: LCQ Fleet (manufactured by Thermo Fisher Scientific)
Analysis condition B: Under the following conditions, an ion ionized under the conditions of a capillary voltage of −35 V and a tube lens voltage of −110 V is detected as an anion.

The ion detected at m/z=325 is selected as a precursor ion. An ion subjected to collision-induced dissociation into an inert gas He at a collision energy of 35 eV is detected.
Ionization method: electrospray method (ESI)
Sheath gas: 10 (arb. unit)
Aux gas: 5 (arb. unit)
Spray voltage: 5 kV
Capillary temperature: 275° C.
Mobile phase: methanol (JIS K 8891 standard equivalent)
Column not used (no stationary phase)
Flow rate: 1 mL/min
Injection volume: 10 μL
Chromatogram detector: UV detector
MS acquisition time: 5 min
MS measurement range: 50 to 1,500 m/z
Collision inert gas: He (helium)
Collision energy: 35 eV

### Quantitative Determination of Dodecylbenzenesulfonic Acid or Dodecylbenzenesulfonate in Toner

The quantitative determination of dodecylbenzenesulfonic acid or dodecylbenzenesulfonate in the toner is performed by LC/MS measurement of a methanol extract from the toner. A calibration curve is prepared using sodium dodecylbenzenesulfonate as a standard, and the quantitative determination is performed.

### LC/MS Analysis Conditions

Model: Agilent 6130 Quadropole LC/MS (manufactured by Agilent Technologies)
Eluent: methanol
Column: ZORBAX Eclipse Plus C18 (1.8 μm, 100×4.6 mm I.D.) (manufactured by Agilent Technologies)
Flow rate: 1.0 mL/min
Column temperature: 30° C.

### EXAMPLES

Although the present disclosure will be described in more detail below with production examples and examples, these are not intended to limit the invention in any way. In all the following formulations, the term “part(s)” refers to part(s) by mass.

### Production Example 1 of Polyester A

Adduct of bisphenol A with 2 mol of ethylene oxide (BPA-EO): 25 parts by mole
Adduct of bisphenol A with 2 mol of propylene oxide (BPA-PO): 75 parts by mole
Isophthalic acid: 100 parts by mole

The above monomers were charged into a flask equipped with a stirrer, a nitrogen inlet tube, a temperature sensor, and a rectifying column. The temperature was increased to 190° C. over 1 hour. It was confirmed that the reaction system was stirred uniformly. To 100 parts of these monomers, 1.0 part of tin distearate was added. The temperature was increased from 190° C. to 250° C. over a period of 5 hours while the produced water was removed by distillation. The dehydration condensation reaction was then performed at 250° C. for 2 hours.

As a result, a polyester A-1 having an Mn of 8,000 and an Mw/Mn of 3.5 was prepared.

### Production Examples 2 to 6 of Polyester A

Polyesters A-2 to A-6 were prepared in the same manner as in Production Example 1 of the polyester A, except that the monomers used in Production Example 1 of Polyester A were changed as presented in Table 1, and the reaction temperature and the dehydration condensation time were changed in such a manner that Mn and Mw/Mn of the resulting polyesters A were desired values. The results are presented in Table 1.

TABLE 1

| Polyester A | A-1 | A-2 | A-3 | A-4 | A-5 | A-6 |
|---|---|---|---|---|---|---|
| Isophthalic | 100 | 90 | 60 | 90 | 90 | 55 |
| acid | | | | | | |
| (amount | | | | | | |
| by mole) | | | | | | |
| Terephthalic | 0 | 10 | 40 | 10 | 10 | 45 |
| acid | | | | | | |
| (amount | | | | | | |
| by mole) | | | | | | |
| Total acid | 100 | 100 | 100 | 100 | 100 | 100 |
| (amount | | | | | | |
| by mole) | | | | | | |
| BPA-EO | 25 | 20 | 25 | 38 | 12 | 25 |
| (amount | | | | | | |
| by mole) | | | | | | |
| BPA-PO | 75 | 60 | 75 | 52 | 78 | 75 |
| (amount | | | | | | |
| by mole) | | | | | | |
| Ethylene glycol | 0 | 20 | 0 | 10 | 10 | 0 |
| (amount | | | | | | |
| by mole) | | | | | | |
| Total alcohol | 100 | 100 | 100 | 100 | 100 | 100 |
| (amount | | | | | | |
| by mole) | | | | | | |
| Mn | 8000 | 3200 | 9800 | 2800 | 10600 | 8500 |
| Mw/Mn | 3.5 | 2.6 | 3.6 | 2.3 | 3.4 | 3.4 |
| (Uᵢₛₒ/total | 100 | 90 | 60 | 90 | 90 | 55 |
| acid) × 100 | | | | | | |
| (U_{EO} + | 100 | 80 | 100 | 90 | 90 | 100 |
| U_{PO})/total | | | | | | |
| alcohol × 100 | | | | | | |
| U_{PE}/(U_{PO} + | 25.0 | 25.0 | 25.0 | 42.2 | 13.3 | 25.0 |
| U_{EO}) × 100 | | | | | | |

### Production Example 1 of Crystalline Polyester

1,10-Decanedicarboxylic acid: 100 parts by mole
1,9-Nonanediol: 100 parts by mole
Tin dioctylate as catalyst: 0.8 parts based on 100 parts of total acid alcohol

The above materials were placed in a heat-dried two-necked flask. Nitrogen gas was introduced into the container to maintain an inert atmosphere. The temperature was increased with the mixture being stirred. The mixture was then stirred at 170° C. for 6 hours. Thereafter, the temperature was gradually increased to 230° C. under reduced pressure while stirring was continued, and the mixture was held for another 3 hours. When the mixture reached a viscous state, the mixture was air-cooled to stop the reaction, thereby producing a crystalline polyester 1. The obtained physical properties are presented in Table 2.

### Production Examples 2 and 3 of Crystalline Polyester

Crystalline polyesters 2 and 3 were produced in the same manner as in Production Example 1 of the crystalline polyester, except that the alcohol monomer and the acid monomer used were changed as presented in Table 2. The physical properties of crystalline polyesters 2 and 3 are presented in Table 2.

TABLE 2

| | Crystalline polyester 1 | Crystalline polyester 2 | Crystalline polyester 3 |
|---|---|---|---|
| Alcohol monomer | 1,9-nonanediol | 1,12-dodecanediol | 1,12-dodecanediol |
| Acid monomer | 1,12-dodecanedioic acid | sebacic acid | adipic acid |
| Acid value | 2 | 3 | 4 |
| Melting point ° C. | 70 | 80 | 74 |
| Mn | 11000 | 10000 | 14000 |
| Mw/Mn | 2.1 | 2.1 | 2.3 |

### Preparation of Resin Particle Dispersion of Polyester A-1

Polyester A-1:100 parts
Methyl ethyl ketone: 50 parts
Isopropyl alcohol: 20 parts

Methyl ethyl ketone and isopropyl alcohol were added to a container. The polyester A-1 was gradually added and completely dissolved by stirring to prepare a polyester A-1 solution. The container containing the polyester A-1 solution was set at 65° C. A total of 5 parts of a 10% aqueous ammonia solution was gradually added dropwise to the container while the mixture was stirred. Furthermore, 230 parts of ion-exchanged water was gradually added dropwise at a rate of 10 mL/min to perform phase inversion emulsification. The solvent was removed with an evaporator under reduced pressure, thereby providing a resin particle dispersion of the polyester A-1. The volume average particle diameter of the resin particles contained in this resin particle dispersion was 130 nm. The solid content of the resin particles was adjusted to 20% with ion-exchanged water.

### Preparation of Resin Particle Dispersion of Crystalline Polyester 1

Crystalline polyester 1:100 parts
Methyl ethyl ketone: 50 parts
Isopropyl alcohol: 20 parts

Methyl ethyl ketone and isopropyl alcohol were added to a container. The crystalline polyester 1 was gradually added and completely dissolved by stirring to prepare a crystalline polyester 1 solution. The container containing the crystalline polyester 1 solution was set at 40° C. A total of 3.5 parts of a 10% aqueous ammonia solution was gradually added dropwise to the container while the mixture was stirred. Furthermore, 230 parts of ion-exchanged water was gradually added dropwise at a rate of 10 mL/min to perform phase inversion emulsification. The solvent was removed under reduced pressure, thereby providing a resin particle dispersion of the crystalline polyester 1. The volume average particle diameter of the resin particles in this resin particle dispersion was 150 nm. The solid content of the resin particles was adjusted to 20% with ion-exchanged water.

### Preparation of Colorant Particle Dispersion

Copper phthalocyanine (Pigment Blue 15:3): 45 parts
Ionic surfactant NEOGEN RK (sodium dodecylbenzenesulfonate, manufactured by DKS Co., Ltd.): 5 parts
Ion-exchanged water: 190 parts

The above components were mixed and dispersed for 10 minutes with a homogenizer (Ultra-Turrax, manufactured by IKA). The mixture was then subjected to dispersion treatment for 20 minutes at a pressure of 250 MPa with an Ultimizer (counter-impingement type wet grinder, manufactured by Sugino Machine Limited), thereby providing a colorant particle dispersion having a volume average particle size of colorant particles of 120 nm and a solid content of 20%.

### Preparation of Release Agent Particle Dispersion

Release agent (hydrocarbon wax, melting point: 79° C.): 15 parts Ionic surfactant NEOGEN RK (manufactured by DKS Co., Ltd.): 2 parts Ion-exchanged water: 240 parts

The above materials were heated to 100° C. and sufficiently dispersed with the Ultra-Turrax T50 manufactured by IKA. The mixture was heated to 115° C. with a pressure discharge type Gorlin homogenizer and subjected to dispersion treatment for 1 hour to provide a release agent particle dispersion having a volume average particle size of the release agent particles of 160 nm and a solid content of 20%.

### Preparation of Toner Core Particle Dispersion 1

Polyester A-1 resin particle dispersion: 90.0 parts
Crystalline polyester 1 resin particle dispersion: 10.0 parts
Colorant particle dispersion: 5.0 parts
Release agent particle dispersion: 8.0 parts

The above-described materials were charged into a round stainless steel flask and mixed. Subsequently, the mixture was dispersed at 5,000 rpm for 10 minutes with a homogenizer Ultra-Turrax T50 (manufactured by IKA). After the pH was adjusted to 8.0 by adding a 1 mol/L aqueous solution of sodium hydroxide, an aqueous solution prepared by dissolving 0.50 parts of aluminum chloride in 20 parts of ion-exchanged water was added as a coagulant over 10 minutes while the mixture was stirred at 30° C. After the mixture was allowed to stand for 3 minutes, an increase in temperature was initiated. The temperature was increased to 50° C., forming core particles.

The volume average particle diameter of the formed aggregated particles was appropriately checked by using a Coulter Multisizer III, and the aggregation step was terminated when aggregated particles having a particle diameter of 6.0 μm were formed.

Thereafter, as a spheroidization step, a 1 mol/L aqueous solution of sodium hydroxide was added to adjust the pH to 9.0, and the mixture was heated to 92° C. while stirring was continued.

When a desired surface shape was obtained, the heating was stopped. The mixture was cooled to room temperature, thereby providing a toner core particle dispersion 1.

### Preparation Example of Monomer Dispersion 1 Containing Fine Silica Particles and Resin Component

Styrene: 100 parts
Methacryloxypropyltrimethoxysilane: 20 parts
Colloidal silica: 70 parts

The above materials were dispersed using a homogenizer (Ultra-Turrax T50, manufactured by IKA). The temperature in the container was adjusted to 25° C. The mixture was stirred for 1 hour to provide a monomer dispersion 1 for agglomerates containing fine silica particles and a resin component.

### Preparation Examples of Monomer Dispersions 2 to 9 Containing Fine Silica Particles and Resin Component

Monomer dispersions 2 to 9 for agglomerates containing silica and a resin component were prepared in the same manner as in the preparation of the monomer dispersion 1 containing silica and the resin component, except that the amount by parts and material types were changed as presented in Table 3.

TABLE 3

| | | | Binder component | | Silica | | |
|---|---|---|---|---|---|---|---|
| | | Amount | | Amount | | | Amount |
| | | added in | | added in | | | added in |
| | | dispersion | | dispersion | | Particle | dispersion |
| | Monomer | step | | step | | diameter | step |
| | A | [parts] | Monomer B | [parts] | Type | [nm] | [parts] |
| Monomer | styrene | 100 | methacryloxypropyltrimethoxysilane | 20 | colloidal | 105 | 70 |
| dispersion | | | | | silica | | |
| 1 | | | | | | | |
| Monomer | styrene | 100 | methacryloxypropyltrimethoxysilane | 10 | colloidal | 105 | 70 |
| dispersion | | | | | silica | | |
| 2 | | | | | | | |
| Monomer | styrene | 100 | methacryloxypropyltrimethoxysilane | 30 | colloidal | 105 | 70 |
| dispersion | | | | | silica | | |
| 3 | | | | | | | |
| Monomer | styrene | 100 | methacryloxypropyltrimethoxysilane | 20 | fumed | 35 | 70 |
| dispersion | | | | | silica | | |
| 4 | | | | | | | |
| Monomer | styrene | 100 | methacryloxypropyltriethoxysilane | 20 | colloidal | 105 | 60 |
| dispersion | | | | | silica | | |
| 5 | | | | | | | |
| Monomer | styrene | 40 | methacryloxypropyltrimethoxysilane | 0 | colloidal | 105 | 95 |
| dispersion | | | | | silica | | |
| 6 | | | | | | | |
| Monomer | — | — | — | — | colloidal | 105 | 100 |
| dispersion | | | | | silica | | |
| 7 | | | | | | | |
| Monomer | styrene | 120 | methacryloxypropyltrimethoxysilane | 0 | colloidal | 105 | 70 |
| dispersion | | | | | silica | | |
| 8 | | | | | | | |
| Monomer | styrene | 100 | methacryloxypropyltrimethoxysilane | 40 | colloidal | 105 | 70 |
| dispersion | | | | | silica | | |
| 9 | | | | | | | |

Production examples of toners will be described below.

### Production Example of Toner 1

First, 2.75 parts of the monomer dispersion 1 prepared by the above method and 0.005 parts of potassium persulfate were added to the toner core particle dispersion 1 in such an amount that the amount of the toner core particles was 100 parts. The temperature in the container was adjusted to 90° C. The mixture was stirred for 2 hours using a Fullzone impeller, thereby preparing a toner particle dispersion 1.

Hydrochloric acid was added to the resulting toner particle dispersion 1 to adjust the pH to 1.5 or less. The mixture was stirred and allowed to stand for 1 hour. Solid-liquid separation was then performed using a pressure filter, thereby obtaining a toner cake. The cake was re-slurried with ion-exchanged water to form a dispersion again, and then subjected to solid-liquid separation by the above-mentioned filter. The re-slurrying and the solid-liquid separation were repeated until the electric conductivity of the filtrate was 5.0 μS/cm or less. Then, solid-liquid separation was finally performed to obtain a toner cake. The resulting toner cake was dried and then classified with a classifier to provide toner particles 1 including agglomerates on the surfaces of the toner particles. The weight average particle diameter of the toner particles 1 was 6.9 μm.

External addition was performed to the toner particles 1. The following external addition was performed with an FM mixer (FM10, manufactured by Nippon Coke & Engineering Co., Ltd.): 20.0 g of hydrophobic fine silica particles (number average particle diameter of primary particles: 7 nm) surface-treated with dimethylsilicone oil were added to 2.0 kg of the toner particles 1, and then the mixture was mixed at 3,000 rpm for 5 minutes. At this time, the temperature in the container after 5 minutes of mixing was adjusted to 35° C. by controlling the flow and temperature of cold water flowing through a cooling jacket.

Thereafter, the toner was sieved with a mesh having an opening of 75 μm to provide a toner 1. The physical properties of the toner 1 are presented in Table 4-3.

### Production Examples of Toners 2 to 28

Toner particles 2 to 28 and toners 2 to 28 were produced in the same manner as in Production Example 1 of the toner 1, except that the amount, material type, and production conditions were changed as presented in Tables 4-1 and 4-2. The physical properties of the resulting toners 2 to 28 are presented in Table 4-3.

TABLE 4-1

| | | Binder resin | | | | | | | | | | | | |
|---|---|---|---|---|---|---|---|---|---|---|---|---|---|---|
| | | Polyester A | | | | | | | | | | | | |
| | | | | | | | | | | (U_{EO} + | | | | |
| | | | Isophthalic | Terephthalic | BPA- | BPA- | Ethylene | | | U_{PO}) | | | Crystalline | |
| | Toner | | acid | acid | EO | PO | glycol | | | (Total | | | polyester | |
| Toner | particle | | (amount | (amount | (amount | (amount | (amount | | Mw/ | alcohol × | | Amount | | Amount |
| No. | No. | Type | by mole) | by mole) | by mole) | by mole) | by mole) | Mn | Mn | 100 | [symbol] | (parts) | Type | (parts) |
| 1 | 1 | A-1 | 100 | 0 | 26 | 76 | 0 | 8000 | 3.5 | 100 | 25 | 90 | 1 | 10 |
| 2 | 2 | A-1 | 100 | 0 | 25 | 75 | 0 | 8000 | 3.5 | 100 | 25 | 90 | 1 | 10 |
| 3 | 3 | A-1 | 100 | 0 | 25 | 75 | 0 | 8000 | 3.5 | 100 | 25 | 90 | 1 | 10 |
| 4 | 4 | A-1 | 100 | 0 | 25 | 76 | 0 | 8000 | 3.5 | 100 | 35 | 97 | 1 | 10 |
| 5 | 5 | A-1 | 100 | 0 | 25 | 76 | 0 | 8000 | 3.5 | 100 | 25 | 70 | 1 | 10 |
| 6 | 6 | A-1 | 100 | 0 | 25 | 75 | 0 | 8000 | 3.5 | 100 | 25 | 90 | 2 | 10 |
| 7 | 7 | A-1 | 100 | 0 | 25 | 76 | 0 | 8000 | 3.5 | 100 | 25 | 90 | 3 | 8 |
| 8 | 8 | A-1 | 100 | 0 | 26 | 76 | 0 | 8000 | 3.5 | 100 | 25 | 90 | 1 | 30 |
| 9 | 9 | A-1 | 100 | 0 | 26 | 75 | 0 | 8000 | 3.5 | 100 | 25 | 90 | 1 | 1 |
| 10 | 10 | A-1 | 100 | 0 | 25 | 76 | 0 | 8000 | 3.5 | 100 | 35 | 90 | 1 | 0 |
| 11 | 11 | A-1 | 100 | 0 | 26 | 60 | 0 | 8000 | 3.5 | 100 | 25 | 90 | 1 | 0 |
| 12 | 12 | A-2 | 100 | 0 | 20 | 75 | 20 | 3200 | 2.6 | 80 | 25 | 90 | 1 | 0 |
| 13 | 13 | A-3 | 100 | 0 | 25 | 52 | 0 | 9800 | 3.6 | 100 | 25 | 90 | 1 | 0 |
| 14 | 14 | A-4 | 100 | 0 | 38 | 78 | 10 | 2800 | 2.3 | 90 | 42 | 90 | 1 | 0 |
| 15 | 16 | A-5 | 100 | 0 | 12 | 52 | 10 | 10600 | 3.4 | 90 | 13 | 90 | 1 | 0 |
| 16 | 16 | A-4 | 100 | 0 | 38 | 78 | 10 | 2800 | 2.3 | 90 | 42 | 90 | 1 | 0 |
| 17 | 17 | A-5 | 100 | 0 | 12 | 53 | 10 | 10600 | 3.4 | 90 | 13 | 90 | 1 | 0 |
| 18 | 18 | A-4 | 100 | 0 | 38 | 78 | 10 | 2800 | 2.3 | 90 | 42 | 90 | 1 | 0 |
| 19 | 19 | A-5 | 100 | 0 | 12 | 75 | 10 | 10600 | 3.4 | 90 | 13 | 90 | 1 | 0 |
| 20 | 20 | A-3 | 100 | 0 | 25 | 76 | 0 | 9800 | 3.6 | 100 | 25 | 90 | 1 | 0 |
| 21 | 21 | A-1 | 100 | 0 | 25 | 76 | 0 | 8000 | 3.5 | 100 | 25 | 90 | 1 | 0 |
| 22 | 22 | A-6 | 66 | 46 | 26 | 75 | 0 | 8500 | 3.4 | 100 | 25 | 90 | 1 | 10 |
| 23 | 23 | A-1 | 100 | 0 | 26 | 75 | 0 | 8000 | 3.5 | 100 | 25 | 0 | 1 | 10 |
| 24 | 24 | A-1 | 100 | 0 | 25 | 75 | 0 | 8000 | 3.5 | 100 | 25 | 90 | 1 | 10 |
| 25 | 26 | A-1 | 100 | 0 | 25 | 76 | 0 | 8000 | 3.5 | 100 | 25 | 40 | 1 | 10 |
| 25 | 26 | A-1 | 100 | 0 | 26 | 76 | 0 | 8000 | 3.5 | 100 | 25 | 90 | 1 | 10 |
| 27 | 27 | A-1 | 100 | 0 | 25 | 75 | 0 | 8000 | 3.5 | 100 | 25 | 40 | 1 | 10 |
| 28 | 28 | A-1 | 100 | 0 | 25 | 75 | 0 | 8000 | 3.5 | 100 | 35 | 40 | 1 | 10 |

[symbol]

indicates data missing or illegible when filed

“Amount (parts)” in Table 4-1 indicates the amount of the resin particle dispersion used in the preparation of the toner core particle dispersion.

TABLE 4-2

| | | Agglomerate | | | | |
|---|---|---|---|---|---|---|
| | Toner | Monomer | | | | |
| Toner | particle | dispersion | Amount | | Amount | |
| No. | No. | No. | [parts] | Additive | [parts] | Stirring conditions |
| 1 | 1 | 1 | 2.75 | potassium persulfate | 0.005 | Fullzone impeller only |
| 2 | 2 | 2 | 0.60 | potassium persulfate | 0.001 | Combination of Fullzone impeller and |
| | | | | | | homogenizer |
| 3 | 3 | 4 | 5.00 | potassium persulfate | 0.002 | Fullzone impeller only |
| 4 | 4 | 6 | 2.00 | potassium persulfate | 0.004 | Fullzone impeller only |
| 5 | 5 | 5 | 2.75 | potassium persulfate | 0.005 | Fullzone impeller only |
| 6 | 6 | 1 | 2.75 | potassium persulfate | 0.005 | Fullzone impeller only |
| 7 | 7 | 1 | 2.75 | potassium persulfate | 0.005 | Fullzone impeller only |
| 8 | 8 | 1 | 2.75 | potassium persulfate | 0.005 | Fullzone impeller only |
| 9 | 9 | 1 | 2.75 | potassium persulfate | 0.005 | Fullzone impeller only |
| 10 | 10 | 1 | 2.75 | potassium persulfate | 0.005 | Fullzone impeller only |
| 11 | 11 | 1 | 2.75 | potassium persulfate | 0.005 | Fullzone impeller only |
| 12 | 12 | 1 | 2.75 | potassium persulfate | 0.005 | Fullzone impeller only |
| 13 | 13 | 1 | 2.75 | potassium persulfate | 0.005 | Fullzone impeller only |
| 14 | 14 | 1 | 2.75 | potassium persulfate | 0.005 | Fullzone impeller only |
| 15 | 15 | 1 | 2.75 | potassium persulfate | 0.005 | Fullzone impeller only |
| 16 | 16 | 1 | 2.75 | potassium persulfate | 0.005 | Fullzone impeller only |
| 17 | 17 | 1 | 2.75 | potassium persulfate | 0.005 | Fullzone impeller only |
| 18 | 18 | 1 | 2.75 | potassium persulfate | 0.005 | Fullzone impeller only |
| 19 | 19 | 1 | 2.75 | potassium persulfate | 0.005 | Fullzone impeller only |
| 20 | 20 | 2 | 2.75 | potassium persulfate | 0.004 | Fullzone impeller only |
| 21 | 21 | 3 | 2.75 | potassium persulfate | 0.006 | Fullzone impeller only |
| 22 | 22 | 1 | 2.75 | potassium persulfate | 0.005 | Fullzone impeller only |
| 23 | 23 | 1 | 2.75 | potassium persulfate | 0.005 | Fullzone impeller only |
| 24 | 24 | 7 | 2.75 | — | — | Fullzone impeller only |
| 25 | 25 | 8 | 2.75 | potassium persulfate | 0.005 | Fullzone impeller only |
| 26 | 26 | 9 | 2.75 | potassium persulfate | 0.005 | Fullzone impeller only |
| 27 | 27 | 1 | 2.75 | potassium persulfate | 0.005 | Fullzone impeller only |
| 28 | 28 | 1 | 2.75 | potassium persulfate | 0.005 | Fullzone impeller only |

In Table 4-2. “Amount (parts)” indicates the amount added to the toner core particle dispersion in such an amount that the amount of the toner core particles is 100 parts.

TABLE 4-3

| | | Physical properties of toner | | | | | | | | |
|---|---|---|---|---|---|---|---|---|---|---|
| | | | | | Percentage | Percentage | | | | |
| | | | | | by number | by number | | | | |
| | | | | | Ca of | Cb of | | | | |
| | | | | Initial | agglomerate | agglomerate | | | | |
| | | Aluminum | | percentage | after | after | | | | Area fraction |
| | | content of | | by number | treatment | treatment | | | Feret's | of resin |
| | | toner | | Cl of | under | under | | | diameter Ag | component |
| | Toner | particle | Average | agglomerate | condition A | condition B | | | of | of |
| Toner | particle | (% by | circularity | [% by | [% by | [% by | | | Agglomerate | agglomerate |
| No. | No. | mass) | of toner | number] | number] | number] | Ca/Cl | Cb/Cl | [nm] | [%] |
| 1 | 1 | 0.032 | 0.970 | 6.4 | 6.3 | 1.9 | 0.99 | 0.30 | 4000 | 40.0 |
| 2 | 2 | 0.032 | 0.970 | 4.3 | 4.3 | 1.3 | 0.99 | 0.30 | 1000 | 7.0 |
| 3 | 3 | 0.032 | 0.970 | 10.1 | 9.6 | 1.0 | 0.95 | 0.10 | 4000 | 45.0 |
| 4 | 4 | 0.032 | 0.970 | 7.2 | 6.6 | 0.7 | 0.91 | 0.10 | 900 | 5.0 |
| 5 | 5 | 0.032 | 0.970 | 4.9 | 4.9 | 1.5 | 0.99 | 0.30 | 8100 | 50.0 |
| 6 | 6 | 0.032 | 0.970 | 6.4 | 6.3 | 1.9 | 0.99 | 0.30 | 900 | 4.9 |
| 7 | 7 | 0.032 | 0.970 | 6.4 | 6.3 | 1.9 | 0.99 | 0.30 | 8100 | 50.2 |
| 8 | 8 | 0.032 | 0.970 | 6.4 | 6.3 | 1.9 | 0.99 | 0.30 | 900 | 4.9 |
| 9 | 9 | 0.032 | 0.970 | 6.4 | 6.3 | 1.9 | 0.99 | 0.30 | 8100 | 50.2 |
| 10 | 10 | 0.032 | 0.970 | 6.4 | 6.3 | 1.9 | 0.99 | 0.30 | 8100 | 50.2 |
| 11 | 11 | 0.032 | 0.970 | 6.4 | 6.3 | 1.9 | 0.99 | 0.30 | 900 | 4.9 |
| 12 | 12 | 0.032 | 0.970 | 6.4 | 6.3 | 1.9 | 0.99 | 0.30 | 8100 | 50.2 |
| 13 | 13 | 0.032 | 0.970 | 6.4 | 6.3 | 1.9 | 0.99 | 0.30 | 900 | 4.9 |
| 14 | 14 | 0.032 | 0.970 | 6.4 | 6.3 | 1.9 | 0.99 | 0.30 | 8100 | 50.2 |
| 15 | 15 | 0.032 | 0.970 | 6.4 | 6.3 | 1.9 | 0.99 | 0.30 | 900 | 4.9 |
| 16 | 16 | 0.032 | 0.970 | 6.4 | 6.3 | 1.9 | 0.99 | 0.30 | 8100 | 50.2 |
| 17 | 17 | 0.032 | 0.970 | 6.4 | 6.3 | 1.9 | 0.99 | 0.30 | 900 | 4.9 |
| 18 | 18 | 0.032 | 0.970 | 6.4 | 6.3 | 1.9 | 0.99 | 0.30 | 8100 | 50.2 |
| 19 | 19 | 0.032 | 0.970 | 6.4 | 6.3 | 1.9 | 0.99 | 0.30 | 900 | 4.9 |
| 20 | 20 | 0.032 | 0.970 | 1.0 | 0.9 | 0.1 | 0.90 | 0.10 | 900 | 4.9 |
| 21 | 21 | 0.032 | 0.985 | 15.0 | 15.0 | 6.0 | 1.00 | 0.40 | 8100 | 50.2 |
| 22 | 22 | 0.032 | 0.970 | 6.4 | 6.3 | 1.9 | 0.99 | 0.30 | 4000 | 40.0 |
| 23 | 23 | 0.032 | 0.970 | 6.4 | 6.3 | 1.9 | 0.99 | 0.30 | 4000 | 40.0 |
| 24 | 24 | 0.032 | 0.970 | 6.4 | 6.3 | 1.9 | 0.99 | 0.30 | 4000 | 40.0 |
| 25 | 25 | 0.032 | 0.970 | 7.1 | 6.9 | 0.7 | 0.97 | 0.10 | 1000 | 5.0 |
| 26 | 26 | 0.032 | 0.970 | 6.0 | 5.9 | 2.5 | 0.99 | 0.42 | 8000 | 50.0 |
| 27 | 27 | 0.032 | 0.970 | 0.5 | 0.4 | 0.1 | 0.89 | 0.09 | 900 | 4.6 |
| 28 | 28 | 0.032 | 0.970 | 15.0 | 15.0 | 7.5 | 1.00 | 0.50 | 8200 | 51.0 |

### Example 1

As an image-forming apparatus for toner performance evaluation, an HP LaserJet Enterprise Color M555dn, which is a color laser printer equipped with a one component toner contact developing blade cleaning system, and an HP212X black toner cartridge (W2120X) CRG, which is a consumable cartridge thereof, were modified and used.

The main body was modified in such a manner that the process speed was 150% and the printing test could be performed only at the black station. The cartridge was modified to increase the capacity of a toner container in such a manner that the toner was contained in a toner filling amount described below, and the following evaluations 1 to 4 were performed. In this way, a configuration was achieved that enables image formation on a larger number of sheets in a faster apparatus than before. The evaluation results are presented in Table 5.

### Evaluation 1. Decrease in Density During Image Formation on Large Number of Sheets in High-Temperature and High-Humidity Environment

As the evaluation of image density, image density was evaluated after images were formed on a large number of sheets in a high-temperature and high-humidity environment (temperature: 30° C., relative humidity: 80%). The printer main body and the toner cartridge filled with 550 g of the toner 1 were left for one day in an environment of 30° C. and 80% RH for the purpose of temperature and humidity control in the evaluation environment. Thereafter, one solid black image (toner bearing amount: 0.6 mg/cm²) was output on LETTER size XEROX 4200 paper (manufactured by XEROX, 75 g/m²) in the same environment. This solid black image was used as an initial solid black image. Subsequently, under the same environment, images with a printing ratio of 1.0% were output on 20,000 sheets, and then a solid black image was output. This solid black image was used as a solid black image after the image formation on a large number of sheets. The densities of the initial solid black image and the solid black image after the image formation on a large number of sheets were measured with a Macbeth reflection densitometer (manufactured by Macbeth). It was determined that a smaller difference between the reflection density of the initial solid black image and the reflection density of the solid black image after the image formation on 20,000 sheets resulted in a lower decrease in image density.
A: Outstanding (difference is less than 0.06)
B: Excellent (difference is 0.06 or more and less than 0.12)
C: Good (difference is 0.12 or more and less than 0.18)
D: Poor (difference is 0.18 or more)

### Evaluation 2. Decrease in Density During Image Formation on Large Number of Sheets in Normal-Temperature and Normal-Humidity Environment

As the evaluation of image density, image density was evaluated when images were formed on a large number of sheets in a normal-temperature and normal-humidity environment (temperature: 25° C., relative humidity: 55%). The printer main body and the toner cartridge filled with 550 g of the toner 1 were left for one day in an environment of 25° C. and 55% RH for the purpose of temperature and humidity control in the evaluation environment. A solid black image was then output in the same environment. This solid black image was used as an initial solid black image. Subsequently, under the same environment, images with a printing ratio of 1.0% were output on 20,000 sheets, and then a solid black image was output. This solid black image was used as a solid black image after the image formation on a large number of sheets. The densities of the initial solid black image and the solid black image after the image formation on a large number of sheets were measured with a Macbeth reflection densitometer (manufactured by Macbeth). It was determined that a smaller difference between the reflection density of the initial solid black image and the reflection density of the solid black image after the image formation on 20,000 sheets resulted in a lower decrease in image density.
A: Outstanding (difference is less than 0.06)
B: Excellent (difference is 0.06 or more and less than 0.12)
C: Good (difference is 0.12 or more and less than 0.18)
D: Poor (difference is 0.18 or more)

### Evaluation 3: Vertical Streak During Image Formation on Large Number of Sheets in High-Temperature and High-Humidity Environment

As the evaluation of image density, vertical streak evaluation was performed when images were formed on a large number of sheets in a high-temperature and high-humidity environment (temperature: 30° C., relative humidity: 80%). The printer main body and the toner cartridge filled with 550 g of the toner 1 were left for one day in an environment of 30° C. and 80% RH for the purpose of temperature and humidity control in the evaluation environment.

Subsequently, in the same environment, images with a printing ratio of 1.0% were output on 20,000 sheets, and then a solid black image was output. Then, a halftone image (H. T. image) was printed, and the number of vertical streaks on the image was measured.
A: Outstanding (no streaks)
B: Excellent (slight streak, 1 streak)
C: Good (clearly visible streak, 1 streak)
D: Poor (clearly visible streaks, 2 or more streaks)

### Evaluation 4: Uneven Density During Image Formation on Large Number of Sheets in High-Temperature and High-Humidity Environment

As the evaluation of image density, uneven density was evaluated when images were formed on a large number of sheets in a high-temperature and high-humidity environment (temperature: 30° C., relative humidity: 80%). The printer main body and the toner cartridge filled with 550 g of the toner 1 were left for one day in an environment of 30° C. and 80% RH for the purpose of temperature and humidity control in the evaluation environment. Subsequently, in the same environment, images with a printing ratio of 1.0% were output on 20,000 sheets, and then a solid black image was output. The density of the resulting solid black image was randomly measured at 20 points, and evaluation was performed by the difference between the maximum value and the minimum value of the measured density.
A: Outstanding (density difference is less than 0.10)
B: Excellent (density difference is 0.10 or more and less than 0.20)
C: Good (density difference is 0.20 or more and less than 0.30)
D: Poor (density difference is 0.30 or more)

### Examples 2 to 21 and Comparative Examples 1 to 7

Evaluations were performed in the same manner as in Example 1 except that the toner 1 was changed to the toners 2 to 28. The evaluation results are presented in Table 5.

TABLE 5

| | | Evaluation 1 | Evaluation 2 | | Evaluation 4 |
|---|---|---|---|---|---|
| | | Change in image | Change in Image | Evaluation 3 | Uneven density |
| | | density in high- | density in normal | Vertical streak in | in high- |
| | | temperature and | temperature and | high-temperature | temperature and |
| | Toner | high-humidity | normal humidity | and high-humidity | high-humidity |
| Example | No. | environment | environment | environment | environment |
| Example 1 | toner 1 | A (0.02) | A (0.01) | A | A (0.01) |
| Example 2 | toner 2 | A (0.04) | A (0.02) | A | A (0.02) |
| Example 3 | toner 3 | A (0.05) | A (0.03) | A | A (0.03) |
| Example 4 | toner 4 | B (0.06) | A (0.03) | A | A (0.03) |
| Example 5 | toner 5 | B (0.07) | A (0.04) | A | A (0.03) |
| Example 6 | toner 6 | B (0.06) | A (0.04) | A | A (0.03) |
| Example 7 | toner 7 | B (0.07) | A (0.05) | A | A (0.04) |
| Example 8 | toner 8 | B (0.07) | B (0.06) | B | A (0.04) |
| Example 9 | toner 9 | B (0.08) | B (0.06) | B | A (0.05) |
| Example 10 | toner 10 | B (0.07) | B (0.06) | B | A (0.06) |
| Example 11 | toner 11 | B (0.08) | B (0.07) | B | A (0.07) |
| Example 12 | toner 12 | B (0.09) | B (0.08) | B | A (0.07) |
| Example 13 | toner 13 | B (0.10) | B (0.09) | B | A (0.07) |
| Example 14 | toner 14 | B (0.09) | B (0.09) | B | A (0.07) |
| Example 15 | toner 15 | B (0.10) | B (0.09) | B | A (0.08) |
| Example 16 | toner 16 | B (0.10) | B (0.09) | B | A (0.08) |
| Example 17 | toner 17 | B (0.11) | B (0.10) | B | A (0.09) |
| Example 18 | toner 18 | B (0.10) | B (0.10) | B | B (0.13) |
| Example 19 | toner 19 | B (0.11) | B (0.10) | B | B (0.14) |
| Example 20 | toner 20 | C (0.17) | C (0.15) | C | C (0.23) |
| Example 21 | toner 21 | C (0.12) | B (0.11) | C | C (0.21) |
| Comparative Example 1 | toner 22 | D (0.19) | C (0.17) | C | C (0.24) |
| Comparative Example 2 | toner 23 | D (0.18) | C (0.16) | C | C (0.24) |
| Comparative Example 3 | toner 24 | D (0.28) | B (0.11) | D (4 streaks) | C (0.32) |
| Comparative Example 4 | toner 25 | D (0.26) | D (0.20) | D (3 streaks) | C (0.29) |
| Comparative Example 5 | toner 26 | D (0.24) | C (0.17) | C | C (0.26) |
| Comparative Example 6 | toner 27 | D (0.25) | D (0.19) | D (2 streaks) | C (0.27) |
| Comparative Example 7 | toner 28 | D (0.23) | C (0.16) | C | C (0.25) |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-044930, filed Mar. 21, 2024, and No. 2025-027675, filed Feb. 25, 2025, which are hereby incorporated by reference herein in their entirety.

What is claimed is:

1. A toner, comprising:
toner particles each containing a binder resin,
wherein the binder resin contains 50% or more by mass of a polyester A containing 60 mol % or more of a unit derived from isophthalic acid as an acid component,
the toner includes agglomerates on surfaces of the toner particles, each of the agglomerates containing silica and a resin,
the toner has a CI (% by number) of 1% or more by number and 15% or less by number, CI being a percentage by number of the toner particles including the agglomerates, and
expressions (1) and (2) are satisfied:
$$0.9 \leq Ca / CI \leq 1. \qquad expression ( 1 )$$
$$0.1 \leq Cb / CI \leq 0.4 \qquad expression ( 2 )$$
where Ca is a percentage by number of the toner particles including the agglomerates when the toner has been treated under ultrasonic condition A:
ultrasonic condition A: output frequency 30 kHz, output capacity 0.75 W, and irradiation time 300 seconds, and
Cb is a percentage by number of the toner particles including the agglomerates when the toner has been treated under ultrasonic condition B:
ultrasonic condition B: output frequency 30 kHz, output capacity 25 W, and irradiation time 300 seconds.

2. The toner according to claim 1, wherein the polyester A contains 90 mol % or more of the unit derived from isophthalic acid as the acid component.

3. The toner according to claim 1, wherein the polyester A contains a unit U_{EO} derived from an ethylene oxide adduct of bisphenol A and a unit U_{PO} derived from a propylene oxide adduct of bisphenol A, and a total proportion of the unit U_{EO} and the unit U_{PO} is 90 mol % or more based on all units derived from alcohol components.

4. The toner according to claim 3, wherein the proportion of the unit U_{EO} to the sum of a proportion of the unit U_{EO} and a proportion of the unit U_{PO}, U_{EO}/(U_{EO}+U_{PO})×100, is 15 mol % or more and 40 mol % or less.

5. The toner according to claim 1, wherein a number-average molecular weight (Mn) of tetrahydrofuran-soluble matter of the polyester A measured by gel permeation chromatography is 3,000 or more and 10,000 or less, and a ratio (Mw/Mn) of a weight-average molecular weight (Mw) to the number-average molecular weight (Mn) is 2.5 or more.

6. The toner according to claim 1, wherein each of the toner particles contains aluminum element in an amount of 0.015% or more by mass and 0.150% or less by mass.

7. The toner according to claim 1, wherein the binder resin contains a crystalline polyester.

8. The toner according to claim 1, wherein the toner has an average circularity of 0.950 or more and 0.980 or less.

9. The toner according to claim 1, wherein an area fraction of a resin component of the agglomerates is 5% or more and 50% or less based on a total area of the agglomerates on a surface of the toner including the agglomerates observed with a scanning electron microscope.

10. The toner according to claim 1, wherein the agglomerates have an arithmetic mean value Ag of Feret's diameters of 1,000 nm or more and 8,000 nm or less.
